(19) United States
(12) Patent Application Publication
(10) Pub. No.: US 2019/0122222 A1
(43) Pub. Date: Apr. 25, 2019

(54) COMPUTER-BASED SYSTEM AND METHOD FOR PAYMENT PROCESSING

(71) Applicant: Edward Yoshio UECHI, Odenton, MD (US)

(72) Inventor: Edward Yoshio UECHI, Odenton, MD (US)

(21) Appl. No.: 15/993,441

(22) Filed: May 30, 2018

Related U.S. Application Data
(60) Provisional application No. 62/576,950, filed on Oct. 25, 2017.

(51) Int. Cl. G06Q 20/42; G06Q 20/12; G06Q 20/40

(52) U.S. Cl. CPC G06Q 20/42; G06Q 20/40145; G06Q 20/405; G06Q 20/12

(57) ABSTRACT

An approach, system, and method for making mobile, in-person, and Website payment transactions directly between a payer and a payee without the need to use cash, credit card, debit card, or a bank. In preferred embodiments, the system improves security by seeking approval from a user associated with an account whenever a request is made to gain access to that account. The system also includes an automatic dispute resolution process whereby a payer and a payee may exchange information to resolve a dispute and wherein the associated accounts are automatically decremented or incremented, as appropriate following resolution of the dispute. A computer program product stores user credentials in a software-based emulated card, which can be used to log in automatically and securely access the functions of a computer program. Another computer program product allows a user to send and receive payments, to review and manage financial records in a general ledger, to cancel, approve, or dispute a financial record, and to accept or reject a reconciliation report of financial records. A consumer may manage fund credits, in an electronic account, which he or she can redeem and convert into any local currency at a money exchange store. The fund credit provides a single medium and a common unit for users across different countries to buy and sell goods and services on the Internet.

This application claims the benefit of provisional application 62/576,950 filed Oct. 25, 2017, the entire content of which is expressly incorporated herein by reference thereto.

### BACKGROUND

### Technical Field

Embodiments of the present invention relate to a computer-based system for processing payment transactions and/or managing financial records. The present disclosure relates to a system whereby two mobile devices positioned within a few centimeters apart can establish a wireless connection and transfer user and payment data between the devices. More particularly, the present disclosure relates to a software-based method of authenticating a user with one or more factors to log in automatically and securely access the functions of a computer program.

### Background

In at least certain prior art systems, a payment processor or a payment gateway, which is operated by a third party organization, is integrated in a Website or a mobile application, and uses computer software to process a payment by credit card or debit card. For example, in a retail store or at a physical kiosk, making a payment by credit card or debit card will typically go through a third party payment processor. This payment processor adds another layer of overhead and another cost of doing business for a merchant to implement and manage. A bank or a financial institution is needed to process a check, carry out an electronic funds transfer, or implement a direct deposit.

Recent innovative methods in mobile computing make it easier and faster to pay for goods and services, but the means of making a payment has not substantially changed. A virtual or digital wallet in a mobile application (e.g., AndroidPay or ApplePay) creates a link to a user's credit card or debit card. Payment processing may not be directly observable in a virtual wallet, but the processing is still routed through a payment processor in the background.

In the absence of a credit card, a debit card, or a bank account, cash is often the only option left to pay for goods and services. Cash, of course, cannot be physically sent through a Website or a mobile application. This creates a predicament for many people, especially those who live in poverty in general and in developing countries in particular. Many people are unable to obtain a credit card or to maintain a bank account. Banks are unlikely to approve loans for impoverished persons. A Catch-22 arises in that impoverished persons often cannot escape their predicament because they have neither the credit history nor the financial means in the first place. A system is needed that allows impoverished persons to participate in commerce and to demonstrate creditworthiness to financial institutions and business partners. There needs to be a solution for those who rely on cash to be able to participate in the online community where they too can be consumers of goods and services.

An on-going problem related to processing payments involves ensuring security and protecting user data. Dealing directly in cash has well-known risks including human safety concerns. Safeguarding cash in a bank provides security and reduces risks. A credit card or a debit card offers convenience in buying something, especially when a person does not have cash available on hand. But a physical credit card can be lost or stolen. And the original card holder must wait for a new credit card to be delivered. While computer technology can implement security controls, an unauthorized person could still make a payment by using a stolen card or by submitting someone else's credit card number without having the physical card. A hardware token can be linked with a software program to provide two factors of user authentication, adding a second layer of security. But like a credit card, a hardware token can be lost or stolen. Moreover, manufacturing hardware tokens requires raw materials and the provisioning of hardware tokens for millions of people can be costly.

Separate from payment processing is the security problem surrounding logging in to a Website or a computer program with a User ID and password combination. The issues related to entering user credentials are well known. A computer program can enforce a complex password pattern, but such a password is difficult to remember. Another method can have a user submit a short code that they received within a few seconds from their mobile phone, but this method is often implemented in combination with the manual user login. A hardware token can be linked with user login, but this method requires a physical item. A smart card or a physical card with a magnetic stripe can be implemented that can automatically log in a user, but this method also requires a physical item. A biometric sensor can be implemented to log in a user automatically, but this method requires additional hardware in the computer.

The banking sector is under greater pressure to ensure that money does not flow to known or suspected terrorist groups. In recent years, legitimate small business firms that deal solely in cash transactions have had funds in their bank accounts mistakenly seized by law enforcement. Adequate and timely reporting that discerns legitimate businesses from criminal actors would improve the transacting of large sums of money. Such reporting that shows who is paying whom and for what purpose would enable law enforcement to weed out legitimate firms and hone in on suspected groups.

### SUMMARY OF THE INVENTION

In one aspect, the invention is directed to a computer-based method for processing transactions related to payments in exchange for goods or services, the method comprising the steps of receiving an electronic request for access to an account associated with an electronic payment processing system, determining whether the request is authentic using an authentication protocol, and, if the request is not determined to be authentic, rejecting the access request, otherwise preliminarily approving the access request. If the access request is preliminarily approved, the method may also send a message to a user associated with the account notifying the user that the access request has been preliminarily approved. The method may receive a response to the message indicating user approval or disapproval of the access request. If the response from the user indicates disapproval of the access request then the method will deny access to the account. If the response from the user indicates approval of the access request, then the method will change the status of the access request from preliminarily approved to approved and the electronic payment processing system will process a payment associated with the account.

In preferred embodiments the authentication protocol comprises determining whether a location captured at the time of the request for access is within a predetermined range of the last location at which a successful transaction had been completed for the account. The authentication protocol may also determine whether a location captured at the time of the request for access is within a predetermined distance from the mean value of a compilation of historical locations associated with successful transactions for the account. The authentication protocol may compare a digital image representing the physical appearance of a person captured at the time of the request for access to stored image data associated with the account.

The electronic payment processing system may process a payment associated with the account by decrementing the account and crediting a merchant account associated with a merchant of a good or service. The electronic payment processing system may not process a payment associated with the account in the event that the amount of the payment exceeds a predetermined budget associated with the account. Alternatively, if the amount of the payment exceeds a predetermined budget associated with the account a warning message may be sent to the user. After a warning message is sent to the user, the method may further comprise the step of receiving a response to the warning message from the user, the response including either an approval or a disapproval of the payment. In preferred embodiments, the electronic payment processing system will not process a payment associated with the account in the event that the amount of the payment, when combined with all payments processed for the account during a predetermined period of time will collectively exceed a predetermined budget associated with the account.

In another aspect, the invention features a method for resolving a dispute between a purchaser of a good or service and a merchant who provided the good or service, the method comprising the steps of receiving a message from the purchaser contesting a transaction previously consummated between the purchaser and the merchant, the message containing data concerning the basis for the user contesting the transaction; sending a message to the merchant informing the merchant that the transaction is being contested and providing the data; receiving a message from the merchant containing a response that includes either an acceptance of the basis or a rejection of the basis; and wherein if the message from the merchant includes an acceptance of the basis, automatically crediting an account associated with the purchaser and automatically decrementing an account associated with the merchant.

In preferred embodiments, the method further comprises the step of facilitating an exchange of information between the purchaser and the merchant following the step of sending and before the merchant either accepts or rejects the basis for the user contesting the transaction. The transaction may be for the purchase of goods from the merchant using the Internet. The step of receiving a message from the merchant may further comprise receiving data from the merchant supporting the merchant's reasons for rejecting the basis. The method may further comprise the step of sending a message to the purchaser in the event the merchant rejects the basis and including in the message data received from the merchant supporting the merchant's reasons for rejecting the basis.

In another aspect, the invention features a computer-based method for authorizing users related to user logins in automatically granting or denying access to secure applications, the method comprising the steps of receiving an electronic request for access to an account associated with a third party software application, determining whether the request is authentic using an authentication protocol and, if the request is not determined to be authentic, denying the access request and redirecting the access request to an access denied screen, otherwise granting the access request and redirecting the access request to a secured entry screen of the third party software application. If the access request is denied, the method further includes sending a message to a user associated with the account notifying the user that the access request has been denied and potentially receiving a response to the message indicating user acknowledgement of the access request, wherein when the request for access is granted the third party software application will allow the user to access software functionality therein.

### BRIEF DESCRIPTION OF THE DRAWINGS

The nature and various advantages of certain embodiments will become more apparent upon consideration of the following detailed description, taken in conjunction with the accompanying drawings, in which like reference characters refer to like parts throughout, and in which:

FIG. 1 shows a computer system in three different scenarios to process a payment transaction: (1) a single mobile phone installed with a mobile application program; (2) a retail store (in-person) situation where a touch-screen computer installed with a merchant-focused mobile application program interacts with a mobile phone installed with a customer-focused mobile application program; and (3) a third party Website integrated with an API application program.

FIG. 2A shows the elements that are programmed in three computer programs (a Web application program that processes transactions and generates client tokens in a remote computer server, an Application Programming Interface (API) program that is used to integrate payment processing in a Website or a mobile application, and a user authenticator mobile application program that facilitates user authentication in a mobile device).

FIG. 2B, which is a continuation of FIG. 2A, shows the elements that are programmed in two computer programs (a customer-focused mobile application program that manages transactions in a mobile device and a merchant-focused mobile application program that records sales orders and processes associated payments in a mobile device).

FIG. 3 shows a business process for registering a new user with a step that involves activating a software-based emulated card in a user authenticator mobile application program.

FIG. 4A shows the first part of a business process for processing a payment transaction with security controls in a mobile operation, an in-person operation, and a Website operation.

FIG. 4B, which is a continuation of FIG. 4A, shows the second part of a business process for processing a payment transaction with security controls in a mobile operation, an in-person operation, and a Website operation.

FIG. 5 shows a technical procedure for how a Web application program, a user authenticator mobile application program, a customer-focused mobile application program, and a merchant-focused mobile application program interact with each other to process a payment transaction between two connected mobile devices.

FIG. 6 shows a technical procedure for how a Web application program, a user authenticator mobile application program, and a customer-focused mobile application program interact with each other to process a payment transaction in a single mobile device.

FIG. 7 shows a procedure for how a customer-focused mobile application program creates or modifies a payment transaction for execution on a recurring basis in a Web application program.

FIG. 8 shows a business process for a money exchange store (an example of a retail store situation) to verify a customer and to deposit or withdraw fund credits.

FIG. 9 shows a prior art payment processing system.

FIG. 10 shows a payment processing system in accordance with one embodiment of the present invention.

FIG. 11 shows a prior art user authentication method.

FIG. 12 shows an additional prior art user authentication method.

FIG. 13 shows a user authentication method in accordance with one embodiment of the present invention.

### DETAILED DESCRIPTION OF CERTAIN PREFERRED EMBODIMENTS

Several terms that are used in the following discussion are first defined, as follows.

A “merchant” is a user who markets and sells goods and services. A merchant may also be a customer who buys goods and services from another merchant.

A “customer” or “consumer” is a user who buys goods and services. Usage of customer is applied in the context of a business relationship between a merchant and a customer.

A “payee” is a user who requires and receives a payment from a payer. In most cases, a payee is a merchant. In limited instances, a payee may also be a customer.

A “payer” is a user who is obligated to pay and/or sends a payment to a payee. A payer can be either a merchant or a customer.

A “fund credit” is a form of money that provides a store of value, a unit of account, and a medium of exchange that can be universally applied across multiple countries. The fund credit may be a non-denomination, quantified decimal value that is disassociated with a monetary local currency. It may also be tied to a specific currency. A number of fund credits may be purchased by a customer or can be deposited by another user. In order to redeem its value in cash, a number of fund credits may be withdrawn from the customer's account and exchanged into a local currency.

“Local currency” refers to cash or money authorized by a national government for use in a specific country (i.e., U.S. Dollars for use in the United States, Euros for use in countries within the European Union, and Ghanaian New Cedis for use in Ghana).

A “money exchange store” is a business, commonly found in airports and in developing countries, which provides a service to a customer to exchange a local currency to another local currency (i.e., exchanging Euros into Japanese Yen). A money exchange store can provide a service to exchange (convert) a local currency into a fund credit and vice versa. A bank or a financial institution may provide this service. An unmanned, self-service kiosk may serve as a money exchange store, similar to an Automatic Teller Machine (ATM).

A “user authentication factor” refers to a form of identifying a user. The most common form is a pair of data consisting of a User ID and a password. Another form is a hardware token or a smart card that contains information about a user. A biometric characteristic such as a fingerprint, face recognition, iris detection, or the person's gait, etc. is another form. Using one form to authenticate a user provides convenience but is a weak solution that may be inadequate to protect against unauthorized access. Two or more factors of user authentication provide additional layers that make it more difficult for an unauthorized user to try to break in to a computer system, as the unauthorized user has to get through all implemented forms. Multiple factors of user authentication offer a more robust information security strategy regarding user access.

In one embodiment of the invention, a customer will pay for fund credits before making a purchase. A customer may go to a money exchange store to purchase fund credits. An employer may deposit fund credits into an employee's account, in an alternative form of paying an employee for work performed. The fund credits are stored and reserved for an associated customer to buy a good or a service from a merchant who accepts fund credits. In essence, the fund credits are pre-paid. Pre-payment of fund credits shifts the financial risk to the customer.

A customer may convert their fund credits back into local currency. The fund credit may be backed by a specific local currency, similar to how paper money was backed by gold or silver several decades ago. Alternatively, the fund credits can be a floating currency that is not tied to any particular currency.

The fund credit provides a single medium and a common unit for users across different countries to buy and sell goods and services on the Internet. A merchant may set one price in fund credits and offer that same price to all customers in all countries. For example, a user who resides in the United States or in China can purchase a product offered at 10.75 fund credits. The fund credits can be automatically converted into a local currency for ease of use by the user.

The conversion and maintenance of fund credits provides for a higher degree of security. Only the user who is associated with the fund credits can convert their fund credits into local currency. Whether a user converts from or to a local currency, conversion of fund credits is carried out by a computer-based method, which includes security controls to verify a user.

One embodiment is directed to a computer-based system for processing of financial information related to payment and exchange of a good or a service and management of financial records directly between a payer and a payee without involvement of a third party payment processor. This system includes: two or more remote computer servers that store user account and financial records in an encrypted format and one or more mobile, computing devices that send and receive payment data and electronic storage that stores computer-executable instructions and data that is used by the computer-executable instructions, wherein the two or more remote computer servers, one or more mobile, computing devices, computer-executable instructions and data, together, configure the system to process information by way of network connections.

In one embodiment, remote computer server(s) are configured for conducting the following steps:

receiving a verification processing request to verify a payer, and documenting the request in the form of a message;

verifying the payer by matching one or more factors of user authentication data against the previously confirmed and stored payer's user account data; and

returning a response of the verification request that immediately approves or rejects the payer based on matching user authentication data, and documenting the response in the form of a message.

The factors of user authentication data include one or more of:
a current location captured at time of payment transaction that is not significantly out of range from the last location at which a payer had completed a successful transaction; or
a current location captured at time of payment transaction that is not considerably far from the mean value of a compilation of a payer's historical user locations; or
a digital image file representing the physical appearance of a payer, captured at time of payment transaction; or
a telephone number registered with a payer, or
an e-mail address registered with a payer; or
a pair of user identification name and user secret key registered with a payer, or
a user role type registered with a payer that corresponds with a payee in the payment transaction; or
a client token generated at time of payment transaction and sent to a payer.

When the user authentication data is verified and approved, the following additional steps are conducted:
receiving a first payment processing request to process a payment transaction from a payer or a payee, and documenting the request in the form of a message;
processing the first request to create a pair of financial records associated with the payment transaction;
subtracting fund credits in the associated payer's general ledger as provided in the first request and subsequently created in the financial record;
adding fund credits in the associated payee's general ledger as provided in the first request and subsequently created in the financial record;
updating the general ledgers of the associated payer and the associated payee to document the transfer of fund credits from the transaction and to calculate net gain or loss;
maintaining the financial records temporarily and marking their status as suspended financial records; and
sending a response of the first request to the associated payer and the associated payee, and documenting the response in the form of a message.

The remote computer server(s) of the system may further be configured for receiving a second request to cancel the suspended financial records from either the associated payer or the associated payee, and documenting the request in the form of a message. When the records are in the process of being canceled, the following steps are conducted:
returning a response of the second request to either the associated payee or the associated payer, respectively, to confirm cancelation of the suspended financial records;
receiving a confirmation request that the suspended financial records are canceled;
processing the confirmation request with user input to change the status of the financial records to canceled financial records, and suppressing display from the associated payer and the associated payee;
updating the general ledgers of the associated payer and the associated payee to document the transfer of fund credits from the transaction and to recalculate net gain or loss; and
sending a response of the confirmation request to the associated payer and the associated payee, and documenting the response in the form of a message.

Additionally, the remote computer server(s) can be further configured for receiving a second request to approve the suspended financial records from either the associated payer or the associated payee, and documenting the request in the form of a message. When the records are in the process of being approved, the following steps can be conducted:
returning a response of the second request to either the associated payee or the associated payer, respectively, to confirm approval of the suspended financial records;
receiving the confirmation request that the suspended financial records are approved;
processing the second request to change the status of the financial records to cleared financial records;
updating the general ledgers of the associated payer and the associated payee to document the transfer of fund credits from the transaction and to recalculate net gain or loss; and
sending a response of the second request to the associated payer and the associated payee, and documenting the response in the form of a message.

The system can include the remote computer server(s) being configured for receiving a third request with the associated payer's input indicating a reason from the associated payer to dispute the cleared financial records, and documenting the request in the form of a message; and processing the third request with the associated payer's input to change the status of the financial records to in-dispute financial records. When the records are in the process of being disputed, the following steps can be conducted:
returning a response of the third request to the associated payee to accept dispute of the in-dispute financial records;
receiving an acceptance request with the associated payee's input indicating a reason from the associated payee to invalidate the in-dispute financial records; and wherein the dispute is accepted, conducting the following steps:
processing the acceptance request with the associated payee's input to change the status of the financial records to disputed financial records, and suppressing display from the associated payer and the associated payee;
updating the general ledgers of the associated payer and the associated payee to document the transfer of fund credits from the transaction and to recalculate net gain or loss; and
sending a response of the acceptance request to the associated payer and the associated payee, and documenting the response in the form of a message.

The remote computer server(s) may be further configured for activating a fourth request to reconcile financial records associated with the payer, and documenting the request in the form of a message; processing the fourth request to reconcile the associated payer's general ledger; compiling financial records associated with the payer, and analyzing the compilation to find any inaccuracy or error in the data and if found, labeling the inaccuracy or error with the corresponding record; calculating key budget management statistics comprising: total deposit, total withdrawal, net gain or loss, budget limit and under/over budget percentage; generating and saving the compiled financial records and calculated key budget management statistics as a reconciliation report in a pre-formatted document and labeling the document as an unconfirmed report; and sending an initial result of the fourth request to the associated payer to accept or reject the generated reconciliation report and receiving a response to accept or reject the generated reconciliation report.

If the generated reconciliation report is rejected, the label part of the generated reconciliation report is changed to state an unconfirmed and rejected report, while if it is accepted, the label part of the generated reconciliation report is changed to state a confirmed and accepted report; or a final result of the fourth request is sent to the associated payer to access the generated reconciliation report, and the result is documented in the form of a message.

The remote computer server(s) typically conduct the steps in four segments initiated by four requests and comprising a payment segment, a final approval segment, a dispute segment and a reconciliation segment and may be conducted with one or more pauses depending on a user input occurring along a timeline that spans several minutes to several days from the date of payment. Also, the two or more remote computer servers are further configured for, if verified and on immediately approved, checking the accuracy of the converted fund credit amount by recalculating the conversion from the specified monetary currency amount in the transaction, and if necessary, correcting the amount and documenting the correction.

Additional configurations of the remote computer server(s) provide for sending a first alert notification to inform that a payer's scheduled payment request will be executed in 72 hours, and documenting the first notification in the form of a message; and sending up to three additional alert notifications, e.g., upon 48 hours, 24 hours and 6 hours from scheduled payment execution, if no response received; or receiving a response from one of the sent alert notifications to execute or stop a payer's scheduled payment request. If the payer's scheduled payment request is stopped, the response to stop a payer's scheduled payment request from executing is documented; or the response to mark the scheduled payment request as a stopped payment transaction is processed, and execution is suppressed from occurring on the scheduled date.

Alternatively, a payer's scheduled payment request is processed as a payment transaction, by the following steps:
processing the payment transaction to create a pair of financial records;
subtracting fund credits in the associated payer's general ledger as provided in the request and subsequently created in the financial record;
adding fund credits in the associated payee's general ledger as provided in the request and subsequently created in the financial record;
updating the general ledgers of the associated payer and the associated payee to document the transfer of fund credits from the transaction and to calculate net gain or loss;
marking the status of the financial records as cleared financial records; and
sending a response of the scheduled payment request to the associated payer and the associated payee, and documenting the response in the form of a message.

Furthermore, the remote computer server(s) can be further configured for conducting the following steps:
receiving a request to calculate a budget management statistic related to the budget of a user, and documenting the request in the form of a message;
processing the request to calculate a budget management statistic related to the budget of a user,
calculating the budget management statistic as provided in the request;
comparing the calculated budget management statistic against a threshold amount previously specified and saved by a user;
based on the result of the calculation, selecting one or more actions from which a user can choose to execute immediately to control, correct or adjust to a financial issue;
sending an alert notification describing the result of the calculation and comparison and presenting the one or more actions in the form of input options for user selection, and documenting the notification in the form of a message;
receiving a response with the selected action;
retrieving a pre-defined scripted procedure that corresponds to the selected action; and
executing the retrieved pre-defined scripted procedure.

All these steps result in controlling, correcting or adjusting to a financial issue as identified in the calculation and comparison of the budget management statistic.

When a single instance of a computing device communicates directly with the remote computer server(s), the remote computer server(s) and computing device are configured for conducting the following steps:
retrieving one or more factors of user authentication data by the single instance of a computing device;
reconfirming validity of one or more factors of user authentication data by the two or more remote computer servers, wherein the retrieved factors of user authentication data are sent to two or more remote computer servers;
compiling payment data, the payer's user identification name, the payee's user identification name and any associated sales order identification number to form transaction data by the single instance of a computing device;
sending compiled transaction data as a request to process a payment to two or more remote computer servers; and
receiving a response of a result of a request to process a payment.

The authentication data is as described elsewhere herein.

When a first instance of a computing device is operated by a merchant or a payee and a second instance of a computing device is operated by a customer or a payer, the two computing devices, together, establish a direct network connection that may not permit a third computing device to interfere in or intercept communication with the remote computer server(s). The computing devices are configured for conducting the following steps:
sending a call by the first instance of a computing device to find the second instance of a computing device within a radius of one meter, and
transmitting an acceptance response from the second instance of a computing device to the first instance of a computing device to establish the direct network connection.

If accepted, one or more factors of user authentication data are retrieved by the second instance of a computing device, or validity of one or more factors of user authentication data is confirmed by the remote computer server(s), wherein the retrieved factors of user authentication data are sent to the remote computer server(s).

In this situation, if accepted, one part of user authentication data comprising the user identification name is transmitted from the second instance of a computing device to the first instance of a computing device, while if accepted, payment data, the payer's user identification name, the payee's user identification name and any associated sales order identification number are compiled to form transaction data by the first instance of a computing device, and, if accepted, compiled transaction data as a request to process a payment is sent to the remote computer server(s); and if accepted, a response of a result of a request to process a payment is received.

A preferred implementation of the prior systems is for converting monetary currency into a fund credit or vice versa. This can also convert monetary currency in one country to monetary currency of another country.

The first instance of a computing device is further configured for communicating with a Near Field Communication reader, a digital camera, a mechanical cash acceptor device, and a mechanical cash dispenser device. This allows the computing device to be configured for conducting the following steps:
sending a call to find the second instance of a computing device within a distance of a few centimeters;
capturing a digital image file representing the physical appearance of a payer;
sending captured digital image file for verification of a payer,
converting monetary currency into fund credit or vice versa;
collecting an amount of paper bills as directed in a request to process a payment; and
dispensing an amount of paper bills as directed in a request to process a payment.

Another aspect of certain embodiments relates to a computer-based method for processing of financial information related to payment and exchange of a good or a service and management of financial records directly between a payer and a payee without involvement of a third party payment processor, wherein each step is conducted by remote computer server(s) that store user account and financial records in an encrypted format. This method comprises:
receiving a verification processing request to verify a payer, and documenting the request in the form of a message;
verifying the payer by matching one or more factors of user authentication data against the previously confirmed and stored payer's user account data; and
returning a response of the verification request that immediately approves or rejects the payer based on matching user authentication data, and documenting the response in the form of a message.

The factors of user authentication data are those that are described elsewhere herein. When these are verified and approved, the following steps are conducted:
receiving a first, payment processing request to process a payment transaction from a payer or a payee, and documenting the request in the form of a message;
processing the first request to create a pair of financial records associated with the payment transaction;
subtracting fund credits in the associated payer's general ledger as provided in the first request and subsequently created in the financial record;
adding fund credits in the associated payee's general ledger as provided in the first request and subsequently created in the financial record;
updating the general ledgers of the associated payer and the associated payee to document the transfer of fund credits from the transaction and to calculate net gain or loss;
maintaining the financial records temporarily and marking their status as suspended financial records; and
sending a response of the first request to the associated payer and the associated payee, and documenting the response in the form of a message.

The method can also receive a second request to cancel the suspended financial records from either the associated payer or the associated payee, and documenting the request in the form of a message. The steps following such cancelation are the same as those discussed elsewhere herein. The same is true when the method includes receiving a second request to approve the suspended financial records from either the associated payer or the associated payee, and documenting the request in the form of a message. As above, third and fourth requests can be received and processed.

The invention also relates to a non-transitory processor readable medium for carrying out the computer-based methods described and disclosed herein and comprising processor readable instructions that when executed by the computer processor cause the computer processor to perform the respective methods.

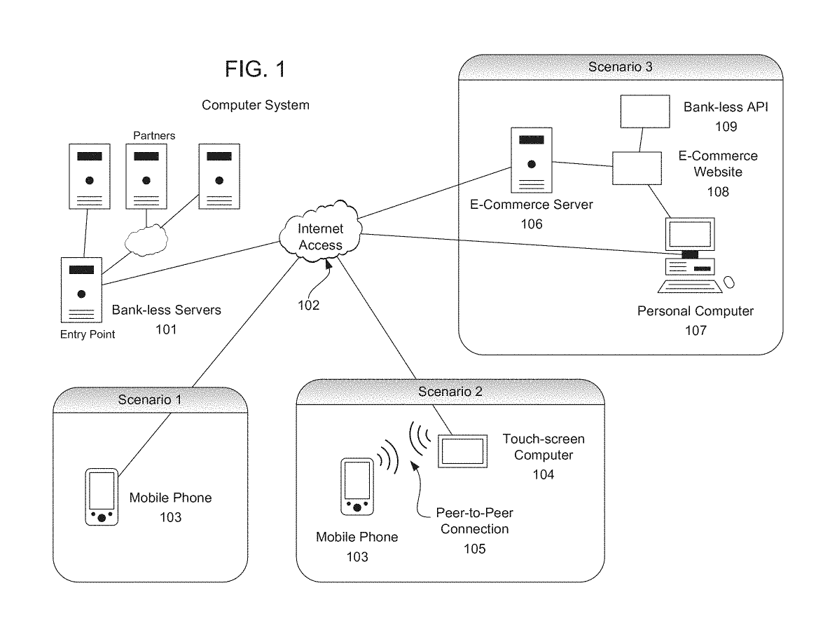

With reference to the figures, FIG. 1 shows a computer system in three different scenarios to process a payment transaction. The data in each scenario are preferably processed by two or more servers unaffiliated with a traditional banking operation (i.e., “Bank-less”) that represent the remote computer servers 101. The preferred embodiment operates numerous Bank-less servers in a distributed network spread geographically across several continents to be capable of hosting millions of user accounts and managing all the payment transactions that are made from all user accounts in total. An IT provider provides oversight and management of the IT infrastructure and computer operations. The IT Provider is a central entity that manages the Information Technology infrastructure (i.e., the computer network(s), the data center(s), and connected computer servers) necessary to operate the present invention. Other entities (i.e., a financial institution, a bank, or a merchant) could work in partnership with the IT Provider to divide roles and responsibilities based on competency and operational focus. There may be one IT Provider that partners with hundreds or thousands of entities. There may also be a group of IT Providers that work with many more partners at a larger scale.

The IT provider has direct management and ownership of the entry point Bank-less server. One or more partners that work in agreement with the IT provider have direct management and ownership of one or more Bank-less servers. A partner can be a financial institution, a bank, or a money exchange store. A merchant could be a partner, but needs to be willing to share increased burden and cost of doing business on top of the merchant's regular operations. The IT provider's partners carry the burden of managing their own remote computer server, which can operate in the same local area network as the entry point server or in a separate network accessible via the Internet. Each partner has the responsibility of administering and managing the records of the user accounts under its control. The partner's remote computer server processes transactions and stores records associated with those user accounts under its control. Partner A, for example, manages the records of 100,000 user accounts and all associated transactions in a rural community. Partner B manages the records of 1,000,000 user accounts and all associated transactions in a large metropolitan city. Each partner keeps the records of its user accounts separated from each other.

Partner B preferably will not access the accounts held by Partner A, and Partner A will not access the accounts held by Partner B. For protection, a user should not be able to directly access any one of the partner Bank-less servers. All Web requests are first processed by the entry point Bank-less server and then forwarded to the respective partner Bank-less server. Responses are returned back to the entry point server and then forwarded on to the user. The IT provider's entry point server coordinates requests and functions primarily to verify every payer in a payment transaction. If verification fails, the entry point server does not forward the request. The configuration of the remote computer servers preferably consists of at least two computer servers—the entry point server and one partner server. This configuration improves on performance and functionality by delegating verification processing and payment processing separately to each computer server. The entry point server focuses on verifying the payer by matching received user data against the stored user's profile information. The partner server then carries out the payment processing but only upon successful verification of the payer. Given the number of user authentication factors involved as described below, verification processing can consume computing resources especially if it requires compiling and analyzing location data and graphical image files. A computer server dedicated to verification processing enables the computer processor to handle each incoming request as quickly as possible. Furthermore, the entry point server only stores data records pertinent to verifying users. Data related to payment transactions and financial records are stored in the partner server.

Although each computer is configured with more or less capacity as described below, all of the computer systems (a Bank-less servers 101, a mobile phone 103, a touch-screen computer 104, an e-commerce server 106, and a personal computer 107) have a microprocessor unit, a storage medium, a memory, an input-output (IO) interface, one or more ports for peripheral devices (if applicable) allowing a user to provide input to the IO interface, a display, and communications circuitry.

Microprocessor units can include any computer processor operative to control the operations and performance of the computer system. For example, the computer processor can be used to run operating system applications, firmware applications, or other applications used to communicate with users and other computer systems. The computer processor can drive the display and process inputs received from a user interface (i.e., the display if it is a touch screen).

Storage media can include, for example, one or more tangible computer storage devices including a hard-drive, solid state drive, flash memory, permanent memory such as ROM, magnetic, optical, semiconductor, or any other suitable type of storage component, or any combination thereof. Storage medium can store, for example, application data for implementing functions on the computer system, authentication information, payment information, user supplied information, financial data, and any other suitable data or any combination thereof. The instructions for implementing the functions of the present invention may, as non-limiting examples, comprise non-transient software and/or scripts stored in the computer-readable media.

Memory can include cache memory, semi-permanent memory such as RAM, and/or one or more types of memory used for temporarily storing data. In some embodiments, memory can also be used for storing data to operate computer system applications, or any other data from storage medium. Memory and storage medium may be combined as a single storage medium.

IO interface can be operative to convert and encode/decode analog signals and other signals into digital data. In some embodiments, IO interface can also convert digital data into another type of signal, and vice versa. For example, 10 interface can receive and convert physical contact inputs from a multi-touch screen such as display, physical movements from a mouse or sensor, analog audio signals from a microphone, or other input. The digital data can be provided to and received from the computer processor, storage medium, and memory, or any other component of the system. The computer system can include multiple IO interfaces.

Ports for peripheral devices can include serial port, parallel port, USB port, video port, or any other suitable port. Peripheral devices can include a button, a keypad, a dial, a click wheel, a pointing device, a touch screen, or a programmable computer readable medium such as flash drive.

Display can include display circuitry for providing a display visible to the user. For example, the display circuitry can include a screen (i.e., an LCD screen) that is incorporated in the computer system. In some embodiments, the display circuitry can include a coder/decoder (Codec) to convert digital data into analog signals and vice versa. For example, the display circuitry or other appropriate circuitry within the computer system can include Codecs necessary to process received financial data and user supplied information, or any other suitable type of Codec.

Communications circuitry can include any suitable communications circuitry operative to connect to a communications network and to transmit communications (i.e., data to and from the computer system to other devices and computer systems). Communications circuitry can be operative to interface with a communications network using any suitable communications protocol such as Wi-Fi, 802.11, Bluetooth, Near Field Communication (NFC), radio frequency systems such as 900 MHz, 1.4 GHz, and 5.6 GHz communication systems, infrared, GSM, GSM plus EDGE, CDMA, quadband, and other cellular protocols, VOIP, or any other suitable protocol. The communications network may also be established by using wires such as an optical fiber or Ethernet cable.

The computer system can include one or more instances of communications circuitry for simultaneously performing several communications operations using different communications networks. For example, the computer system can include a first instance of communications circuitry for communicating over a cellular network, a second instance of communications circuitry for communicating over Wi-Fi, and a third instance of communications circuitry for communicating over an optical fiber.

A computer network exists in a wide area network (WAN) where a client computer in each scenario connects to the remote computer servers via the entry point Bank-less server. This WAN is a connection through the Internet using an Internet Service Provider (ISP) 102. All network connections to the remote computer servers use encryption technology to transfer the data in an encrypted format.

In Scenario 2, one or more touch-screen computers may be connected in a local area network (LAN) within a single physical building or within a cluster of physical buildings in close proximity. All of the computers in the same LAN would use the same WAN to connect to the remote computer servers. The mobile phone and touch-screen computer shown in Scenario 2 of FIG. 1 are connected wirelessly and directly by using direct Wi-Fi, Bluetooth, or Near Field Communication 105. “Direct Wi-Fi” allows a computer to connect directly to another computer in a Peer-to-Peer connection without having to go through a network router. Regardless of the communications protocol, the two directly-connected computers do not need to access the Internet.

Each Bank-less computer server 101 is preferably installed with (1) an operating system application program that may be Microsoft Windows Server, Red Hat Enterprise Linux, or a Unix-based variation; (2) a Web server application program that may be Microsoft Internet Information Services (IIS), Apache, or another Web server variation; and (3) a relational database application program that may be Microsoft SQL Server, Oracle, MySQL, or another SQL-compliant variation. Each Bank-less computer server is configured with one or more physical computer processors, a storage medium with capacity to store hundreds of Gigabytes or one Terabyte or more of data, a significant amount of RAM, preferably of at least 32 Gigabytes, and an optical fiber or Gigabit Ethernet network connection associated with a fixed IP address. Given that data encryption is processor intensive, each computer server should have at least two physical processors, preferably four, to constantly encrypt and decrypt data. A Web application computer program 201 is installed in each Bank-less computer server wherein the computer processor executes the computer-readable instructions programmed in the Web application program.

The Web server application program and the relational database application program may be installed separately in special purpose computer servers, where one special purpose computer server operates as a dedicated Web server to manage and process Web requests and another special purpose computer server operates as a dedicated database server to process and store all data. In this case, the Web application program is only installed in the dedicated Web server.

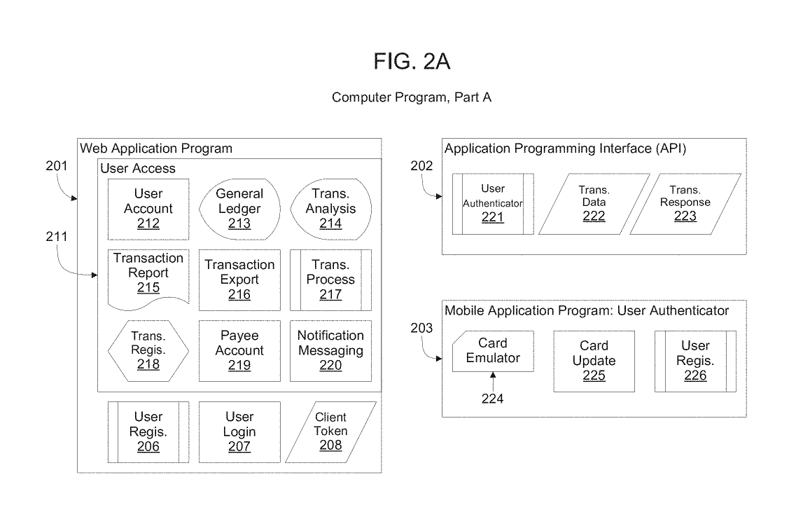

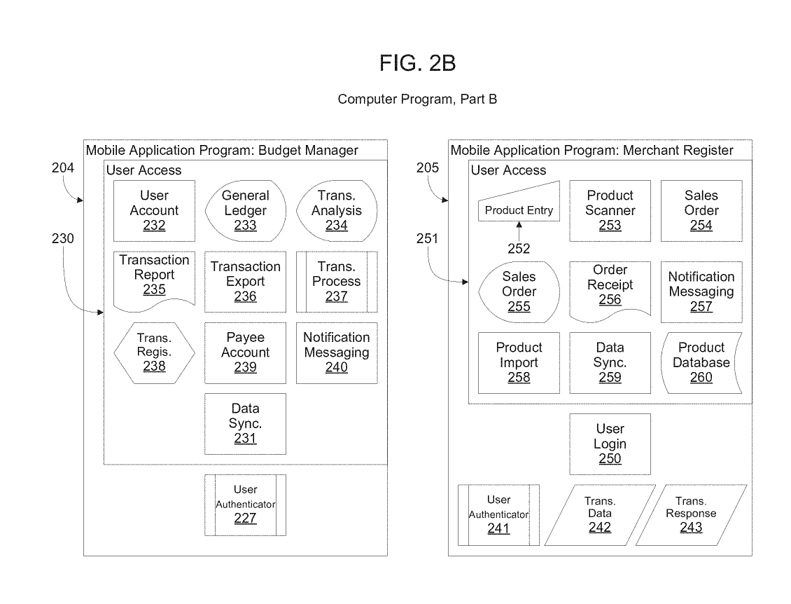

Returning to FIG. 1, in Scenario 1, a mobile phone, a mobile tablet, or similar handheld computing device 103 connects to the remote computer servers 101 via the Internet 102. This mobile device is configured with a single computer processor, a storage medium, memory with limited capacity, a multi-touch display screen, and one or more communications protocols that include cellular, Wi-Fi, Bluetooth, and/or Near Field Communication. Access to the Internet may be either through a cellular connection or a Wi-Fi connection. The mobile device may have a port to install an additional storage medium to increase the capacity of data storage. A user authenticator mobile application program 203 (see FIG. 2A) and a budget manager mobile application program 204 (see FIG. 2B) are installed in the mobile device wherein the computer processor executes the computer-readable instructions to authenticate a user, process a payment transaction, and manage all payment and financial data associated with a user.

The preferred embodiment of Scenario 1 is a single mobile phone that allows a customer to pay for a good or a service in an online situation through a third party Website or mobile application that accepts fund credits. The customer can set up recurring payment transactions to specified merchants or payees. The customer can also manage all of their financial records, deciding to cancel, approve, or dispute a particular record and checking their balance for deficit or surplus.

Whereas Scenario 1 allows an individual user to make a payment online, Scenario 2, shown in FIG. 1, represents a retail store situation where a customer pays a merchant in a face-to-face interaction. A merchant uses a touch-screen computer 104, which is a mobile tablet or a computing device that is typically physically larger than a mobile phone 103. A touch-screen computer 104 may have the same components as a mobile phone but with more capacity in the storage medium and memory and a larger multi-touch display screen. A touch-screen computer 104 may be connected to a barcode reader scanner peripheral device and/or a printer peripheral device via a USB port. Access to the Internet may be through a cellular connection, a Wi-Fi connection, or a wired connection via a local area network. A merchant register mobile application program 205 (see FIG. 2B) is installed in the touch-screen computer 104 wherein the computer processor executes the computer-readable instructions to record a plurality of sales items in a single sales order, process the sales order and the associated payment, and connect to a second mobile device to obtain user and payment data. A customer stands in close proximity to a merchant's touch-screen computer, so that the customer's mobile device can establish a Peer-to-Peer connection link 105 with the touch-screen computer 104. The preferred communications protocol is Near Field Communication, which provides for a more secure connection where the two devices have to be a few centimeters apart. An alternative communications protocol is Bluetooth or direct Wi-Fi. Once the Peer-to-Peer link has been established, the merchant register program 205 locks its connection with the budget manager program 204 to retrieve user authentication data from the user authenticator program 203 via the budget manager program 204. Once it retrieves validated user authentication data, the merchant register program connects via the Internet 102 to the remote computer servers 101, wherein the Web application program processes the payment transaction. Further details on how these programs interact with each other are provided below.

The preferred embodiment of Scenario 2 (FIG. 1) is a touch-screen computer that is connected to a barcode reader scanner and a printer to operate as a Point-of-Sale (POS) system. Each configured touch-screen computer POS system is placed on one or more check-out counters at a retail store. The one or more configured touch-screen computer POS systems may be connected in a LAN with shared access to the Internet. A customer can securely make a payment with a merchant by establishing a Peer-to-Peer connection link between the customer's mobile phone and the merchant's computer POS system. The customer receives on-screen notifications to confirm the payment transaction.

Another embodiment of Scenario 2 is to use two mobile phones where one mobile phone runs the budget manager application program to serve as the customer and the other mobile phone runs the merchant register application program to serve as the merchant. In this case, there would not be any peripheral device connected to the mobile phone. The mobile phone that serves as the merchant is the device that connects to the remote computer servers to process the payment transaction. Two users representing a payer and a payee can securely make a payment in any location (inside a building, outside under the sun, in an urban district, or in a rural village) where Internet access is available.

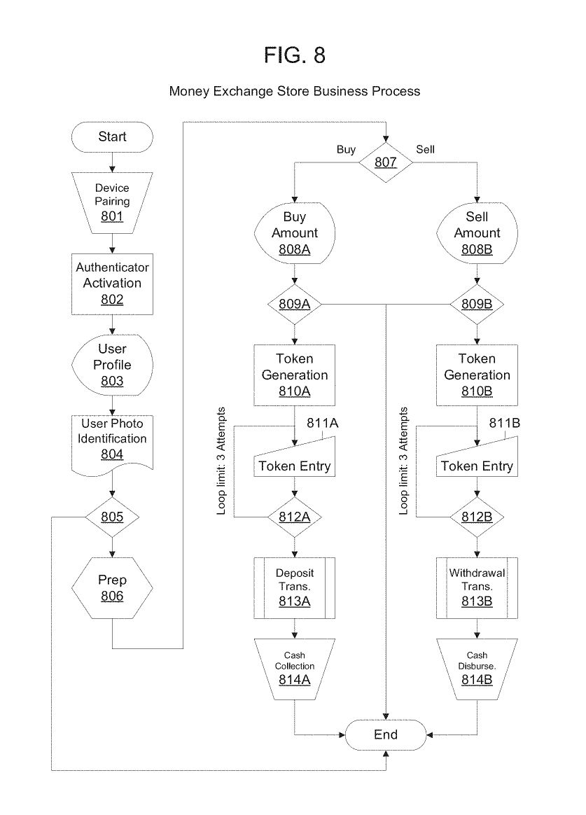

Another embodiment of Scenario 2 is to incorporate a touch-screen computer into an unmanned, self-service kiosk that includes a digital camera, a mechanical cash acceptor, a mechanical cash dispenser, and an Internet connection such as a wired Ethernet connection. The kiosk may include a barcode reader scanner device and/or a printer device. The business process shown in FIG. 8 is completely automated in this kiosk whereby there is no person present to act on behalf of a merchant and a customer can interact with the kiosk with their mobile phone and through a series of on-screen display prompts. Details about how this works are provided below. An application of the kiosk serves as a self-service money exchange store.

In Scenario 3 (FIG. 1), a merchant may have their own Website to market and sell goods and services. The merchant operates or has access to a computer server that is installed with a Web server application program and a relational database application program to run an e-commerce Website. This configuration of the computer server coupled with the Bank-less Application Programming Interface (API) program creates an e-commerce server 106. The Bank-less API 109 allows a third party software developer to integrate the payment processing system into the merchant's Website 108. Details about the API integration are provided below.

A user, the customer, accesses the e-commerce Website 108 with their personal computer 107. The user goes through the Internet 102 to connect to the merchant's e-commerce server 106. At some point in the merchant's shopping cart process, the Bank-less API 109 goes through the Internet 102 via the e-commerce server to connect to the remote computer servers 101 wherein the Web application program authenticates the user and processes the payment transaction. The Bank-less API returns a response whether approved or rejected to the e-commerce server, which in turn relays the response to the user.

The computer hardware preferably utilizes specially designed computer software programs to accomplish the functions related to payment processing and financial management. FIGS. 2A and 2B show the elements that are programmed in five computer programs. The elements indicate what the programs are capable of doing, processing, displaying, generating, and/or operating. Computer program code for carrying out these operations may be written in any one or combination of several object-oriented, procedural, and/or interpretative programming languages, including but not limited to C++, C#, Objective-C, Java, PHP, JSP, ASP, Cold Fusion, JavaScript, XML, CSS, HTML, T-SQL, and PL/SQL. Computer program code defines sets of program instructions that constitute a single computer program product. The computer program product may be installed prior to running, or immediately run without installation on a user's computer in which the program instructions are executed entirely on the user's computer, on a remote computer in which program instructions are executed entirely on the remote computer; or on both a user's computer and a remote computer in which program instructions are executed partially on the remote computer, and partially on the user's computer.

A Web application or Web-based application program 201 (FIG. 2A) includes the following elements: user registration 206, user login 207, client token 208, user account 212, general ledger 213, transaction analysis 214, transaction report 215, transaction export 216, transaction process 217, transaction registration 218, payee account 219, and notification and messaging 220. All of the elements from 212 to 220 are controlled by user access 211. This means that a user must have been authenticated in order to access their user account, general ledger, transaction related information, and any other information that is associated with the user. All data records are processed, managed, and displayed in association with the logged in user. The Web application program may include additional elements to provide more functions and features.

The other three elements, i.e., 206, 207, and 208 are accessible without user authentication. For obvious reasons, user registration and user login can be accessed by an anonymous user. Client token 208 provides another factor (another level) of user authentication that can be enabled in the budget manager mobile application, the merchant register mobile application, and the Bank-less API. Upon request by a client computer, the Web application generates a random numeric code no longer than eight digits, stores it for a limited time period (15 minutes by default), and sends it to the client computer. This short code represents the client token that a user receives in their mobile phone. Within the time limit, the user must enter the short code at the prompt during the payment process in the mobile application or in the e-commerce Website. The Web application automatically deletes the short code, whether used or not, after the time period has expired. The Web application uses the stored short code to match what the user had entered and submitted. The short code may be sent as an SMS text message to the user's registered telephone number or displayed as an on-screen notification in the mobile phone. The time period for expiring the short code may be specified by a user at the time of activating the use of a client token.

User registration 206 provides a data entry form for a user to create and activate a new user account. The Web application processes the user registration form and sets up the account for the user. The Web application continuously connects to the user's mobile phone to check that the user authenticator mobile application is installed; and if installed, updates the software-based emulated card (card emulator) 224 (discussed below) with the user's identification name, secret key, role type, date of registration, and date of update, and then activates the emulated card for use.

A registered user can then log in to the Web application, the mobile application, or the e-commerce Website via the Bank-less API. User login 207 provides a data entry form for a user to enter their user identification name and user password (user credentials). The Web application processes user credentials and if the credentials match will create a time-limited session (10 minutes) in which the logged in user can access any of the elements from 212 to 220. The session time limit preferably cannot be changed by a user. A client token may be generated as part of the user login process to provide another factor of user authentication.

User account 212 provides data entry forms for the user to edit and manage their user information (i.e., legal name, address, country, and telephone number). User status (i.e., active, inactive, or closed) is displayed in user account. The Web application updates the emulated card in the user authenticator mobile application, when changes to user information have been made. This function provides a data entry form for a user to close their user account. If a user chooses to close their account, the Web application processes the user account so that the user can no longer use it. This means the status is changed to closed, information stored on the emulated card is deleted and reset to original settings, and the emulated card is inactivated, which then invalidates the user authenticator mobile application program.

During the entire period that a user account is active, the Web application maintains historical records of all user logins and captured data related to user authentication. This includes but is not limited to previous captures of GPS locations and digital image files. The Web application routinely executes an automated script to analyze historical records to identify errors, breaches, intrusions, or anything else that may serve to identify a compromised user account. An alert notification is sent upon identification of a breach or a compromised account. The Web application also periodically connects to a user's user authenticator application program to monitor its health and status.

General ledger 213 displays all payment transactions as financial records associated with the logged in user. This is a continuous log of every deposit and withdrawal that the user had made since the account was created. The log is displayed in reverse chronological order where the most recent transaction is listed first. Each financial record consists of a transaction identification number, transaction date, transaction type, a payer, a payee, a total amount, a transaction status, a transaction code, an error code, and a brief description. The record is distinguished by its type, which can be a deposit (credit) or a withdrawal (debit). A sales order record that provides a plurality of line items describing one or more goods or services sold, a plurality of additional amounts (i.e., sub amount, shipping and handling, and applicable tax), and other details related to the sales order may be associated with the financial record and available for viewing. Additional information such as request messages, response messages, confirmation messages, alert notifications, user inputs, and user actions are associated with the financial record.

Note that a single payment transaction is associated with a pair of financial records. One financial record is related to a payer and the other financial record is related to a payee. The disclosure herein may refer to financial records in singular or in plural. When presented in singular, one should bear in mind that there is a complementary record that is associated with the transaction.

Depending on the status of the transaction, a financial record provides a specific function to cancel, approve, or dispute the transaction. Within 72 hours (three days) from the transaction date (payment date), a user can cancel or approve the financial record. If no action is taken, the financial record is automatically approved (cleared). Within 336 hours (14 days or two weeks) from the transaction date (payment date), a user can dispute the financial record. If the dispute claim is accepted by the associated payee, the status of the financial record is changed to disputed.

The general ledger displays the status of each financial record by suspended, canceled, cleared, in-dispute, and disputed. The “Suspended” status is applied for a new transaction that had just been made. A user has the opportunity to cancel or approve a suspended financial record. After Suspended status, a financial record can move to “Canceled” or “Cleared” status. The “Cleared” status is synonymous to “Approved.” The “In-Dispute” status means that the dispute claim is being investigated. If accepted, the in-Dispute status changes to “Disputed” status. The Web Application suppresses the display of canceled and disputed financial records, meaning these records are hidden and not counted in the net gain. Canceled and disputed records still exist in the database. Only cleared financial records are counted in the net gain.

Transaction analysis 214 displays statistics and charts related to one or more financial records. Commonly-used statistics relate to the practice of budget management. Examples include but not limited to calculation of deficit or surplus, analysis of net gain or loss, analysis of payments to one payee, and aggregated monthly statistics. Specific calculated amounts include but are not limited to total deposit, total withdrawal, net gain or loss, and under/over budget percentage. The user may save specific settings to provide parameters that limit the number of compiled records or that configure the analysis to better suit their needs. A specific setting is budget limit. The user can save a specific amount that represents the maximum limit that they can spend. Another specific setting is threshold amount.

Transaction report 215 generates the general ledger in a pre-formatted RTF document for the user to download and save to their computer. By default, a transaction report is generated for the most recent completed month where all financial records occurring in the same month are compiled. The user may generate a report for a specified month, a specified quarter, or a specified year. A common report that is generated is a reconciliation report. The user can generate a reconciliation report and the resultant RTF document will be available for download in this section.

Transaction export 216 is similar to transaction report 215 except that the general ledger is in a format that can be imported and read by another computer software application (i.e., Microsoft Excel). Whereas the report function is made to be read by a human user, the export function is made to be read by a machine user. Transaction export 216 generates the general ledger in a plain text file delimited by a comma, tab, or some other character.

Transaction process 217 performs the processing of a payment transaction and works in coordination with a client computer. Details regarding payment processing are provided below.

Transaction registration 218 provides data entry forms for the user to add, edit, and delete a scheduled transaction. The user can set up a payment transaction to occur one time or on a recurring basis in the future. The Web application then carries out the transaction at the scheduled time and in accordance with parameters set up by the user.

Payee account 219 is a parameter that is required in transaction registration that designates who will receive the fund credits in the payment transaction. Payee account provides data entry forms for the user to add, edit, and delete a number of users who will receive fund credits from the logged in user.

Notification and messaging 220 generates and displays alert notifications to the logged in user. An alert notification can be triggered by any one of the elements in the Web application, the mobile application, and the API to inform or prompt the user to take some action. An alert notification may present the user with input options to select and submit. The logged in user may send a message to a payee or another user who has agreed to accept communications. Likewise, the recipient of the message may reply with a subsequent message. The messaging function is restricted to users who know each other or have expressly agreed to send and receive messages. Throughout the entire payment process, a message is automatically generated to document a request, a response, a confirmation, or a user input. The user can access the notification and messaging function to read all messages and alert notifications.

The Web application program uses a cryptographic methodology to encrypt and decrypt nearly all data records. Unlike other application programs that may only encrypt a limited set of data deemed sensitive (i.e., password and government-issued identification number), the preferred embodiments preferably encrypt all information that can identify a person or a business and stores that data in an encrypted format. Upon accessing any data record, the Web application program decrypts the data and holds the decrypted data in memory for reading. New data and modified data are encrypted prior to being stored in the database.

Certain types of data fields may not be included for encryption. Date and time fields, numeric value fields, and system code fields pre-defined by the Web application program may not be encrypted and stored in an encrypted format. These fields alone and in isolation cannot identify any particular user or business. To do that, one needs to combine a date field and a numeric value field with a legal name, an address, or a telephone number. But one must first decrypt a legal name, an address, or a telephone number in order to be useful.

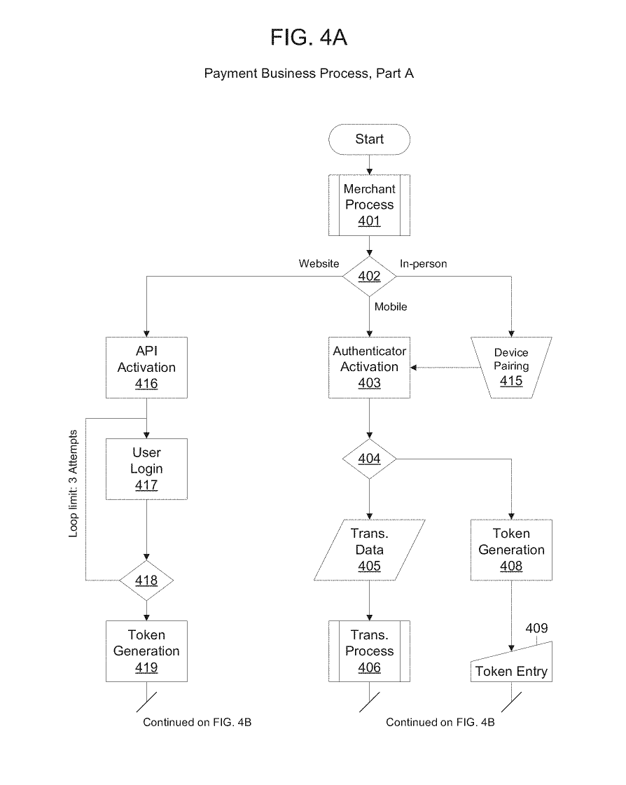

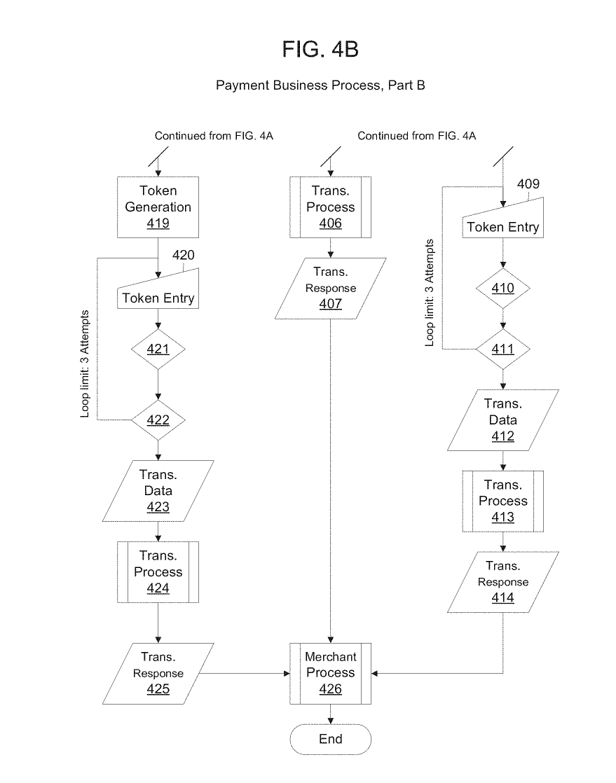

An Application Programming Interface (API) program (the Bank-less API) 202 includes the following elements: user authenticator 221, transaction data 222, and transaction response 223. This computer program is designed to be integrated in a third party e-commerce Website or third party mobile application to communicate with the Web application 201 to carry out and complete a payment transaction. User authenticator 221 provides the instructions to carry out the relevant process steps shown in FIGS. 4A and 4B. User authenticator interacts with the user login and client token elements of the Web application program. Transaction data 222 collects the total amount to be transacted, the payee name, and any other pertinent payment data from the integrated Website or mobile application and sends the compiled data to the transaction processing element of the Web application. Transaction response 223 relays the transaction identification number, transaction code, and any error code from the Web application to the integrated Website or mobile application for display to the user.

A user authenticator mobile application program 203 includes the following elements: card emulator 224, card update 225, and user registration 226. This computer program operates as an independent program physically separate from the other two mobile application programs. The other two mobile application programs depend on this program for user authentication. Card emulator 224 mimics the purpose of a physical credit card by storing the user's identification name, secret key, role type, date of registration, and date of update. Card emulator 224 is a software-based emulated card. Card update 225 provides the instructions to update the information stored in the card emulator and also to activate, inactivate, suspend, or revoke the user authenticator. Card update 225 can be invoked by user registration or a logged in user who makes a change to their user account. The Web application may connect to the user authenticator program and update the information in the card emulator. A systems administrator user can update the card at any time on behalf of the user via the Web application program. For example, a user may have not made any transactions for the past 12 months, which may presume that the user had abandoned the account. As such, a systems administrator may close the user's account and inactivate the user authenticator mobile application program.

User registration 226 functions in the same way as described for the Web application. After installing the user authenticator program for the first time, the user can register from within the authenticator program and activate the program immediately. Of course, user registration in the mobile application should connect to the Web application to process the information and to set up the user account.

A customer-focused mobile application program (the budget manager mobile application program) 204 (FIG. 2B) includes the following elements: user authenticator 227, user account 232, general ledger 233, transaction analysis 234, transaction report 235, transaction export 236, transaction process 237, transaction registration 238, payee account 239, notification and messaging 240, and data synchronization 231. The elements from 232 to 240 function in the same way as described for the corresponding elements in the Web application program. While some functions related to transaction processing and transaction registration require more interaction with the Web application, the budget manager program reduces the amount of time necessary to connect to the remote computer servers. The user can review, manage, and analyze their financial records with a copy of all their records stored in the mobile device. The mobile application program includes a local relational database application program. Data synchronization 231 provides instructions to check that the data records in the mobile device are the same as stored in the Web application by uploading new and modified records and downloading all records associated with the user. All of the elements from data synchronization 231 to notification and messaging 240 are controlled by user access 230. The functions within the user access boundary are not available if the program cannot authenticate the user.

When the budget manager program is launched, the user authenticator process 227 is activated and connects to the user authenticator mobile application program to get information stored in the card emulator. If the card emulator is still valid, user authenticator 227 grants access to the budget manager program. If the user authenticator mobile application program does not exist at all, then the user cannot access any of the functions in the budget manager mobile application program.

The user authentication procedure implemented in the budget manager program automates user login, so that the user does not have to enter user credentials.

A merchant-focused mobile application program (the merchant register mobile application program) 205 has the following elements: user authenticator 241, transaction data 242, transaction response 243, user login 250, product entry 252, product scanner 253, sales order processing 254, sales order display 255, sales order receipt 256, notification and messaging 257, product import 258, data synchronization 259, and product database 260. This program provides functions to record, process, and print a new sales order at the time of data capture and payment transaction. The elements from product entry 252 to product database 260 are controlled by user access 251. Only a user who had been verified as a legal merchant can access the functions in this program.

User login 250 follows the same process as described for the user authenticator process 227 in the budget manager program. The merchant register program also requires the user authenticator mobile application program to be installed in the mobile device. Access will be granted or denied, based on the role type of the user. Access is granted when the role type is a merchant. The card emulator stores user information related to role type. User login in the merchant register program is an automatic login via the user authenticator mobile application program.

Product entry 252 provides a data entry form for a merchant to enter and save one or more goods or services as individual line items to create a new sales order. Each product entry consists of a product identifier or SKU, a name, a quantity, a regular price, and a discounted price (if available). The product data are checked and verified against the stored information in the product database 260.

If the computing device is connected to a barcode reader scanner, product scanner 253 is enabled and activated and provides instructions for decoding a barcode, a QR code, or some other one-dimensional or two-dimensional symbol technology and automatically entering a new product entry item. Product scanner uses the decoded product identifier to check and verify the product against the stored information in the product database 260, and returns the complete product data.

Sales order processing 254 provides the instructions to record all the products that are manually entered or automatically scanned into a sales order. The result of the processing is outputted to the display screen where the merchant can see each product as entered along with the merchant's information, sub amount, shipping and handling amount (if applicable), sales tax amount (if applicable), and total amount 255. Sales order display provides on-screen functions for the merchant to add a new product, edit an existing product, delete an existing product, and change shipping options, upon which the user action returns to sales order processing to re-process the order and re-calculate the sales amounts. Product entry, product scanner (if activated), sales order processing, and sales order display are programmed in coordination to produce a final sales order.

If the computing device has access to a printer, order receipt 256 is enabled and activated and provides instructions to print the details of the sales order on paper. The output may be configured to print on multiple letter-sized, legal-sized, or A4 paper sheets or on a narrow-width paper tape. Various printers capable of printing on different types and widths of paper may be implemented. If the computing device is connected in a local area network, the connected printer may be located on the same computer network. Thus, the printer does not necessarily have to be connected directly to the computing device.

Notification and messaging 257 provides the same functions as described in the corresponding element in the Web application. The logged in user can receive an alert notification and send and receive a message in the merchant register program.

Product import 258 provides data entry forms for the merchant to add, edit, and delete product records individually and in bulk (i.e., multiple records at one time). All product records are stored in the product database, which is a local relational database application program 260. The product database operates in the mobile device for faster access, since the merchant does not need to connect to the network to check and verify each product during product entry.

Data synchronization 259 provides an alternative to loading product records manually, allowing a copy of the product database to be stored in the Web application and synchronized with the mobile application. All of the merchant's sales orders can be downloaded to the mobile application and stored in the mobile device.

The Bank-less API is implemented in the merchant register program with the same elements to carry out and process a payment transaction. But user authenticator 241, transaction data 242, and transaction response 243 are programmed to operate natively within the merchant register mobile application program. As will be described further below, the merchant register program must first discover a nearby mobile device, which is the customer, and establish a Peer-to-Peer connection link. The pairing of the merchant's computing device with the customer's mobile phone then invokes the user authenticator process 241.

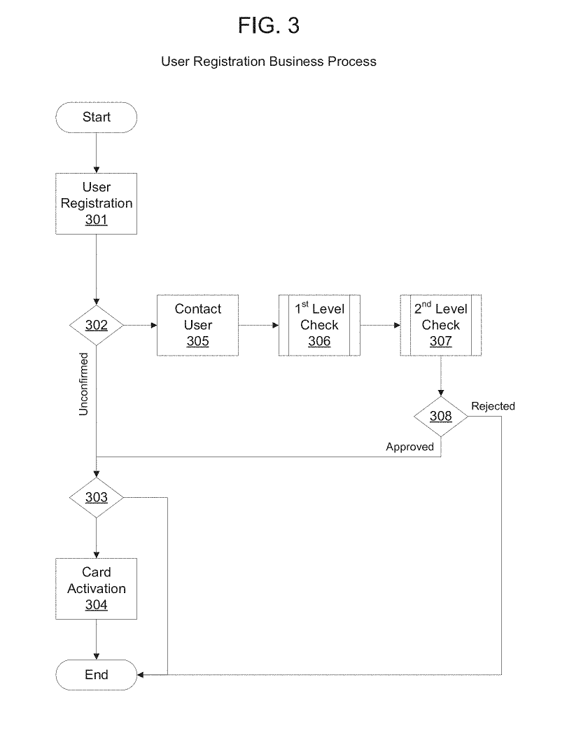

FIG. 3 shows a business process for registering a new user. In the preferred embodiment, user registration takes place in the user authenticator mobile application program. A new user downloads and installs the user authenticator program in their mobile phone or computing device. Because the card emulator has not been updated with any information (all stored data fields are null and empty), the user authenticator program will launch the user registration data entry form. The user must complete and submit user registration 301. The amount of data that is required may be far less than what is expected in completing a credit application form. User registration does not need to require data related to employment, income, and past financial activity. The user will create a unique user identification name and a password. Required personal information can include legal name, home address, city or town, postal code, country of residence, and telephone. Additional data fields for a government-issued identification number, an e-mail address, and a description are optional. The user may upload a digital image file representing their physical appearance or likeness. Alternatively, a digital camera in the computing device may be activated to capture the user's physical appearance and then the captured digital image file may be uploaded. A current location of the computing device represented as a GPS coordinate may be captured and uploaded. The user may select a specific role type: customer or merchant. If the merchant role is selected, which indicates the user intends to sell goods or services on a full-time regular basis, the user will complete the business portion. Required business information includes organization name, business address, city or town, postal code, country of business registration, telephone, and a government-issued tax identification number. Additional data fields about the business such as Website address, business e-mail address, business description, and product or service description are optional. The user will check one or more checkboxes to indicate that they have read one or more legal documents (i.e., sales terms and conditions, terms of use, and privacy policy).

The user submits the completed user registration form to the Web application program for processing and setting up a new user account. Submitted user information including the digital image file and the captured location provides the basis for verifying the user. The Web application generates a unique user secret key, a complex and lengthy alphanumeric string. The Web application uses the current date and time to generate the date of registration.

If the user is a customer as indicated by selecting that role, the process continues straight downward at box 302, toward box 303. For convenience and ease-of-use, no documentary checks need to be performed when the user is a customer. This allows the customer to start using their user account as quickly as possible. However, because no person has actually contacted the customer, the customer's account is labeled as an “Unconfirmed User,” which is visible to all users. This particular label may or may not have negative consequences. It may, though, inhibit a potential merchant from conducting business with the customer who shows that they are an unconfirmed user. Any customer who wants to confirm their account may contact an authorized person who will carry out the documentary checks as described in the merchant verification process. And in most cases, one documentary check consisting of submission of a government-issued form of identification (i.e., driver's license or passport) would be adequate for approving a customer.

The Web application program determines at marker 303 whether the user authenticator program is installed and available. If it is, the Web application program proceeds to card activation 304, where upon the user identification name, user secret key, role type, date of registration, and date of update are stored in the corresponding data fields in the card emulator. Card update element 225 receives a call from the Web application to store the user information. Card update uses the current date and time to generate the date of update. The card emulator is activated by setting the user identification name and the user secret key in the corresponding data fields.

If user registration failed or an error had occurred, then the process will end without having to activate the card.

If the user indicates being a merchant at box 302, then the flow branches to the right and card activation is delayed. Additional steps are required to verify the merchant. The merchant is contacted by telephone and is asked basic questions about their business 305. Two levels of documentary checks are conducted. The first level check entails verifying the merchant's legal status by using the merchant's government-issued tax identification number 306. The second level check entails reviewing information regarding the business operations and activities 307. This may include browsing the merchant's Website, reviewing product brochures, and conducting an Internet search. The objective is to ensure that the merchant is not conducting business that may be illegal or unethical. Additional contacts may be made to obtain more information. A determination on whether to approve or reject the merchant is made at marker 308. If rejected, the process ends without having activating the card and the newly created user account is deleted. If approved, the merchant's status is updated to reflect verified and confirmed and the process continues to decision marker 303. The approved merchant is distinguished by the “Approved Merchant” label, which is visible to all users. If a customer has gone through verification, the approved customer is distinguished by the “Confirmed User” label, which is also visible to all users.

During the time that the merchant is being verified, the Web application program is continuously checking to confirm that the user authenticator program is installed. Upon processing that the merchant has passed verification, the Web application program connects to the user authenticator program to update the card emulator.

If the user had registered using the Web application program and the process has gotten to step 303, the Web application program continuously checks to confirm that the user authenticator program is installed in the user's mobile phone. Once it confirms that the program is installed, the Web application program connects to the user authenticator program to update the card emulator. If the Web application program fails to confirm that the user authenticator program exists after seven days, the newly created user account is deleted.

Any user who wants to become a merchant should go through the additional steps to verify legal and business documentation and must be finally approved. This safeguard measure assures that customers are dealing with legitimate merchants.

Although not required at time of registration, a customer can go through the additional steps to verify personal information and can be finally confirmed at a later point in time. The rank of confirmed customer status is not as important as that of the approved merchant status. Higher priority is on verifying merchants to ensure that every merchant is legitimate.

A newly created user account has zero fund credits. Once the user authenticator program has activated the card emulator, the customer can begin to make a payment. A successful payment on a newly created user account will show a negative balance. And when the customer goes to buy fund credits, the negative balance is the amount that the customer must pay in cash in order to raise the balance up to zero fund credits. For example, if the balance is −50, and the fund credits are pegged to the U.S. dollar, then the customer must pay $50 in the United States to get the balance to zero. If fund credits are not pegged to the U.S. dollar, then an appropriate conversion is applied to determine the number of dollars needed. If the customer pays the equivalent of 80 fund credits, the new balance will be 30 fund credits. In any event, the customer cannot sell their negative balance and expect to receive cash. Any negative balance held in a user account must be paid for.

A customer who maintains the unconfirmed status and never buys any fund credits for 30 days from the date of registration may have their user account inactivated and deleted. The Web application program inactivates the associated user authenticator program and deletes the associated user account. Inactivation and subsequent deletion may occur earlier, if the Web application program detects a continuous flow of withdrawal transactions. The user account will be suspended, and an authorized person will investigate the suspended account. This scenario would likely indicate a fake user account.

Any transfer of fund credits in excess of 1,000 fund credits from one user to another user where a merchant is not involved is preferably declined. Both the payer and the payee must have gone through verification to be finally confirmed. A second, a third, or any subsequent excessive amount preferably cannot occur on the following day from the previous day's transfer or cannot occur in consecutive days or cannot occur within five days. Any excessive amount to be transferred should be carried out through a transaction registration, meaning it must be scheduled to occur at a specified date in the future. Finally, the payer in the transaction should send a message to an authorized person to approve the transaction registration prior to execution. The authorized person will review the transaction and ensure that both the payer and the payee are in good standing (i.e., confirmed status and positive balance). If acceptable, the authorized person updates the status of the transaction registration for clearance to execute the transfer of the excessive amount. These safeguard measures prevent or minimize money laundering.

There preferably should be more than one transaction that transfers 10,000 or more fund credits at one time. Further, such a large amount in a single transaction can preferably only be transacted once in a single month. Moreover, this very large transaction may be subject to reporting to a government agency (i.e., the U.S. Department of Treasury) that has authority to enforce national legislation or implementing regulations on the prevention of illicit money flows, especially in regard to combatting financing to known or suspected terrorist groups. A special transaction code that flags this particular transaction type enables the Web application program to generate a specific report that includes only very large transactions for timely submission to a government agency. This report is generated similar to the reconciliation report described herein but only provides detailed transactions including descriptive reason for transactions marked with the special transaction code. This safeguard measure also prevents or minimizes money laundering.

The IT provider and all of its partners are responsible for administering and managing user accounts that come under their review. Users who do not deal with a partner are referred directly to the IT provider for customer service. A partner such as a financial institution can issue new user accounts for customers and merchants who engage directly with it. The partner would employ one or more persons to administer and manage user accounts. The partner may charge fees for setting up the account and completing documentary checks. The partner may also apply a different exchange rate that allows it to cover the conversion cost and reap a profit when users buy and sell fund credits. Furthermore, the partner may change the settings and modify program code in the Web application program to include additional controls and measures. For example, the partner may introduce a new policy that every account must have a positive balance at a specified amount in order to make a payment transaction.

By default, the present invention allows a user to apply their fund credits to buy goods and services from any and all merchants. A particular partner may, however, choose to restrict its users to only buy goods and services that it offers exclusively to its users. An example is in a merchant loyalty reward program or for a merchant gift card. By specifying a user role other than the general “Customer” role to one that is specific to the partner, the partner can restrict its users to buying only its goods and services. A retail store such as Target, for example, would specify the “Target” role. Another retail store such as Macy's would specify the “Macy's” role. A customer who has a user account with the Target role will have their payment declined when they try to buy a product from Macy's. The Web application program running in Macy's remote computer server will see the different user role and stop the transaction from occurring. The role type (user role) can be added to the transaction data at the time of retrieving the user's identification name and secret key from the user authenticator program. The “Customer” user role allows a customer to buy goods and services from any merchant. On the other hand, a partner-specific user role restricts a customer to buy goods and services exclusive to that partner. Only the partner has the ability to set the user role on behalf of the user. In any case, a user preferably cannot change the user role by themselves when they edit their own user profile.

The IT provider may allocate a number of user authenticator mobile application programs for a specific partner. This modified version of the user authenticator mobile application program comes pre-configured with a pre-defined unique user identification name and a partner-specific user role in the card emulator. Each pre-defined unique user identification name has a corresponding user account pre-registered but not activated. The associated account may also be configured with a specific number of fund credits (say for instance, 100 fund credits), so that it can have a positive value when activated. A customer would download and install this modified program from the partner's Website, and proceed to register. This modified program along with a specified fund credit amount would be implemented as a gift card.

FIGS. 4A and 4B show a business process in three different scenarios for processing a payment transaction. The business process, moreover, focuses on the first of four segments (the payment segment) to ensure that a payment transaction is made by a verified payer. The payment process is incorporated into a merchant's shopping cart process or like business process where a customer proceeds to pay for selected goods or services. At a point 402 in a merchant's business process 401, the payment process can split into one of three modes of operation: mobile operation, in-person operation, or Website operation. The mobile operation represents Scenario 1. The in-person operation represents Scenario 2 and follows the same steps as applied in the mobile operation but with one additional critical step, discussed below. The Website operation reflects Scenario 3.

In the mobile operation, user authentication is activated to identify the customer who is making the payment request 403. If available, a current location of the mobile device as represented by a GPS coordinate (i.e., latitude and longitude), at time of payment transaction, is captured (user authentication factor). If enabled, a digital image file representing the customer's physical appearance or likeness, at time of payment transaction, is captured by a digital camera in the mobile device (user authentication factor). A telephone number of the mobile device, which is in use at time of payment transaction, is captured (user authentication factor). The customer's user identification name and user secret key (user credentials) are retrieved from the user authenticator mobile application program (user authentication factor). If the Web application program returns a response that one of the submitted factors does not match the customer's stored user account information in the remote computer server or is invalid, the business process ends without processing any transaction. An exception to this rule may be with the mismatch of current location and mismatch of the digital image file.

There may be an additional factor of user authentication to verify the customer or the process can continue without the additional factor 404. A particular application may require another layer of security, such as in the case of disbursing cash to the user. Most instances of the process would not need another layer of security. Without the additional factor then, the process continues to transaction data 405. At this step, several data fields are collected and compiled to form the transaction data. These data fields include payment data from the merchant (i.e., total amount, product information, and the merchant's user identification name) and the customer's user identification name. The customer's role type may also be included. A sales order identification number is included in the transaction data, if a sales order was created by the merchant register mobile application program and is associated with the payment. The compiled transaction data is sent as a request to the Web application program for transaction processing 406. The Web application program returns a transaction response, and the response presents an on-screen message to the customer, showing a unique transaction identification number, a transaction code, and an error code (if an error had occurred) 407 (see FIG. 4B). The business process returns to the merchant's shopping cart process, relaying the transaction response for the merchant's use if needed at 426.

An alternative path in the mobile operation is the additional factor of user authentication. Returning to decision marker 404, at step 408 the Web application program generates a random, eight-digit numeric code (client token) and sends it to the customer's mobile phone via the customer's telephone number. The generated client token is temporarily stored in the remote computer server for a specified time limit. The client token may be sent by way of the mobile application program to display as an on-screen notification or as an SMS text message. At 409, the customer will enter the client token as prompted by the mobile application program, and submit it to the Web application. The Web application program carries out two checks. At check 410, the customer's input of the client token must have been received within the time limit. If the customer submits the token after the time limit, the process ends. If within the time limit, the customer's input is checked at 411 to make sure that it matches the generated client token. If the input does not match, the customer has two more tries to enter the correct token. The process ends after three failed attempts to send the client token. On a successful match, transaction data is collected and compiled at 412. At this step, several data fields are collected and compiled to form the transaction data. These data fields include payment data from the merchant (i.e., total amount, product information, and the merchant's user identification name) and the customer's user identification name. The customer's role type may also be included. A sales order identification number is included in the transaction data, if a sales order was created by the merchant register mobile application program and is associated with the payment. The compiled transaction data is sent as a request to the Web application program for transaction processing at 413. The Web application program returns a transaction response, and the response presents an on-screen message to the customer, showing a unique transaction identification number, a transaction code, and an error code (if an error had occurred) at 414. The business process returns to the merchant's shopping cart process, relaying the transaction response for the merchant's use if needed at 426.

Returning to step 402 in FIG. 4A, in the in-person operation, both the merchant and the customer must be present in the same location. The merchant may prompt the customer to walk up closer, so that the customer's mobile phone can be as close as possible to the merchant's touch-screen computer. In the preferred embodiment, the two computing devices are a few centimeters apart. In another embodiment, the two computing devices may be as far as one meter. This then allows the two computing devices to be paired together with an expressed permission by the customer at step 415. The merchant register mobile application program (merchant's computer) communicates with the budget manager mobile application program (customer's computer). The merchant's computer sends a message to connect with the customer's computer. The customer can respond back with an accept or a reject input. If rejected, a Peer-to-Peer connection link is not established and the process ends. If accepted, a Peer-to-Peer connection link is established. The customer retrieves their user identification name from the user authenticator mobile application program and sends it to the merchant's computer. The customer's role type may also be retrieved and sent. At this point, the business process proceeds to follow the steps as described in the mobile operation.

In the Website operation (step 402), the Bank-less API is activated as implemented by the merchant in the merchant's e-commerce Website at 416. The Bank-less API opens a user login data entry form where the customer enters their user credentials 417. User login may present two input fields for a user identification name and a password or one input field for a telephone number or one input field for an e-mail address. The Web application program checks to make sure that the customer's input matches the customer's stored user account information in the remote computer server at 418. If applicable, the Web application program may also check the customer's role type to ensure that the customer is permitted to buy from the merchant. If the input does not match, the customer has two more tries to enter the correct user login data. The process ends after three failed attempts to send the user login data. On a successful match of user login data, the Web application program generates a random, eight-digit numeric code (client token) and sends it to the customer's mobile phone via the customer's telephone number at 419. The generated client token is temporarily stored in the remote computer server for a specified time limit. The client token may be sent by way of the mobile application program to display as an on-screen notification or as an SMS text message. The customer will manually enter the client token as prompted by the e-commerce Website, and then the customer's input is sent to the Web application program via the e-commerce Website at 420 (FIG. 4B). The Web application program carries out two checks. The customer's input of the client token must have been received within the time limit at 421. If the customer submits the token after the time limit, the process ends. If within the time limit, the customer's input is checked to make sure that it matches the generated client token at 422. If the input does not match, the customer has two more tries to enter the correct token. The process ends after three failed attempts to send the client token.

On a successful match of the client token at 422, transaction data is collected and compiled at 423. At this step, several data fields are collected and compiled to form the transaction data. These data fields include payment data from the e-commerce Website (i.e., total amount, product information, and the merchant's user identification name). The customer's user identification name, which was received from the Web application program, is added to the transaction data. The compiled transaction data is sent as a request to the Web application program via the e-commerce Website for transaction processing at 424. The Web application program returns a transaction response to the e-commerce Website, where upon the merchant may display an on-screen message to the customer, showing a unique transaction identification number, a transaction code, and an error code (if an error had occurred) at 425. The merchant may choose not to display the response, discard the response data, or store the response data. The business process returns to the merchant's shopping cart process at 426.

An alternative path in the Website operation may exclude the steps related to the client token. The Bank-less API provides an option for a third party software developer to enable or disable the client token factor in user authentication. If the steps involving generating and verifying the client token are skipped, then the business process proceeds from successful login 418 to transaction data 423.

The foregoing business process shows technical measures to detect fraud. Preferably in all cases, a user must submit user credentials. The mobile operation does this automatically through the user authenticator mobile application program. The e-commerce Website does this by manual data entry. The payment process will not continue when submitted user credentials do not match, and the mismatch is logged and documented in a message. If client token is implemented, a user must submit a time-limited numeric code (client token) for further customer identification. Successful verification of the client token means that the registered user's mobile phone is present and in hand. An unauthorized user would have to have had stolen the customer's phone in order to submit the client token. Unsuccessful verification of the client token will not continue the payment process, and is logged and documented in a message. Automatically in the mobile operation, the captured telephone number at time of payment transaction is matched against the registered user's telephone number stored in the remote computer server. A mismatch of the telephone number will not continue the payment process, and is logged and documented in a message. Automatically in the mobile operation, the captured current location at time of payment transaction is matched against the registered user's last location stored in the remote computer server. A mismatch of the user's location is logged and documented in a message, but may not halt the payment process. The mismatch of the user's location is a warning. An alert notification is sent in the case of the mismatched user location that is significantly out of range from the last location at which the customer had completed a successful transaction. The saved historical records of multiple user locations, if they are clustered in the same location or within a city or a town, provide a strong correlation to user identity. An alert notification may be sent in the case that the user location is considerably far from the mean value of a compilation of historical user locations, and this would not continue the payment process.

In the mobile operation, the captured digital image file at time of payment transaction is matched against the registered user's digital image file stored in the remote computer server. A mismatch of the digital image file is logged and documented in a message, but may not halt the payment process. The mismatch of the digital image file is a warning. An alert notification is sent in the case of the mismatched digital image file. In any event of unsuccessful user authentication, an alert notification is sent to the registered user and stored as a documented message.

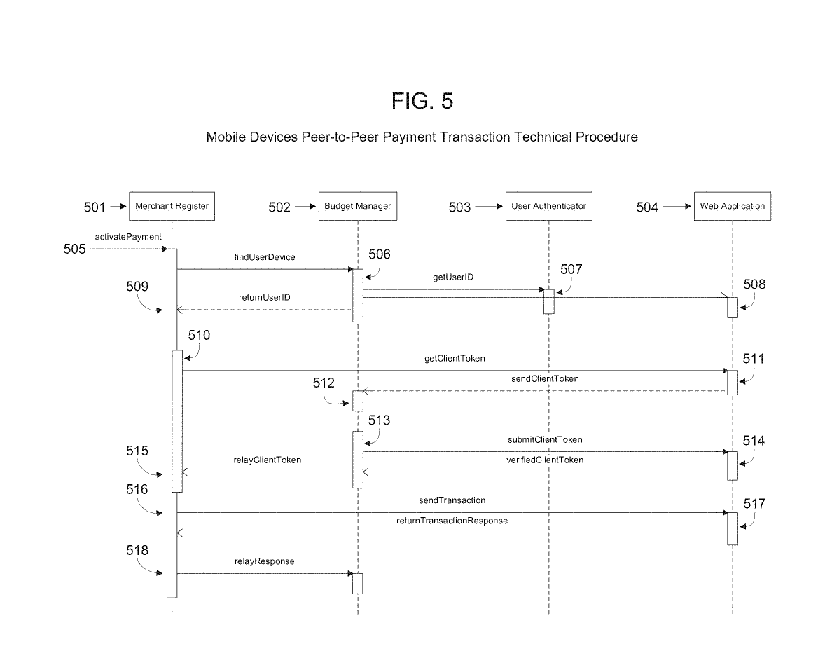

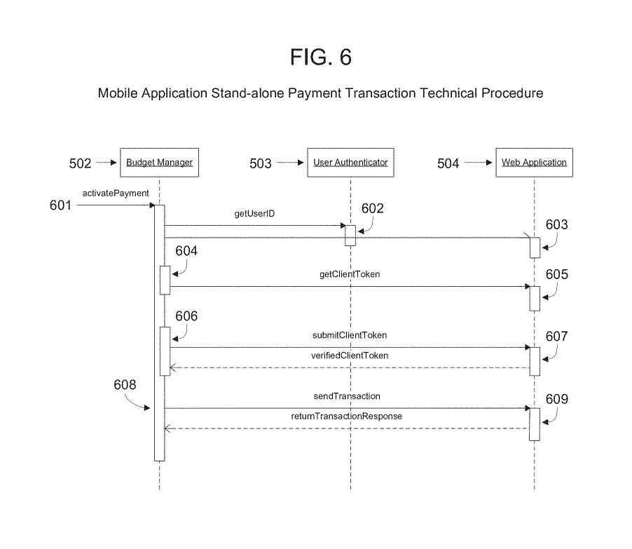

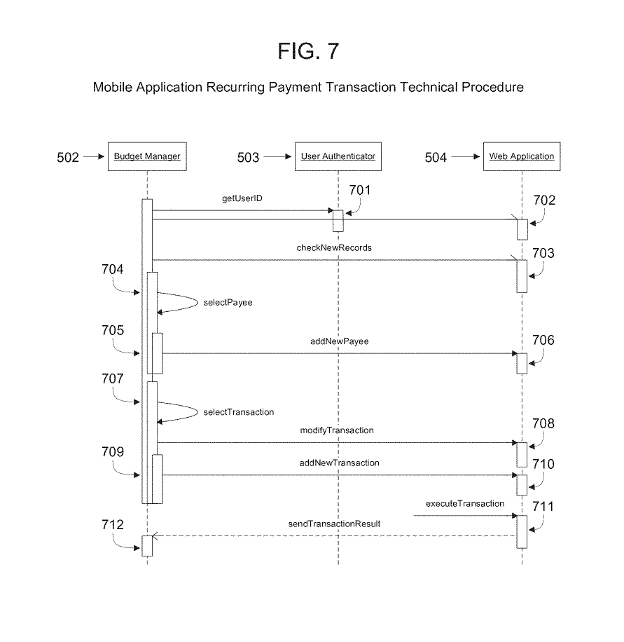

FIGS. 5, 6, and 7 show technical procedures for how the computer programs interact with each other to process a payment transaction. FIG. 5 represents Scenario 2 (in-person operation). FIG. 6 represents Scenario 1 (stand-alone mobile operation). FIG. 7 also represents Scenario 1, but is specific to setting up and executing a recurring payment transaction. The technical procedures in FIGS. 5 and 6 are aligned with corresponding steps as shown and described in FIGS. 4A and 4B. The diagrams illustrate Unified Modeling Language Sequences that show how objects in a software program interact and behave. Each object has an ordered sequence of events that is read from top to bottom along a dotted vertical line, which is called the object's lifeline. An event is represented by a solid rectangle shape, which means that it has been activated. The objects can interact with each other by sending calls. The sequence of calls is read from left to right, top to bottom. A solid arrowhead represents a synchronous call. A half arrow represents an asynchronous call.

The objects represent the computer programs. Referring to FIG. 5, the “Merchant Register” object 501 is programmed in the merchant register mobile application program, which runs in a merchant's touch-screen computer. The “Budget Manager” object 502 is programmed in the budget manager mobile application program, which runs in a customer's mobile phone. The “User Authenticator” object 503 is programmed in the user authenticator mobile application program, which runs in a customer's mobile phone. The “Web Application” object 504 is programmed in the Web application program, which runs in the remote computer server.

The technical procedure in FIG. 5 is activated by an external call, which comes from the merchant's shopping cart process 505. This may be by clicking a button in the merchant register program to execute a procedure to find the customer's mobile phone to establish a Peer-to-Peer connection. The Merchant Register object sends a call to the Budget Manager object to establish a communication link, and the Budget Manager object returns a message to confirm that the communication is permitted and the link has been established 506. The initial call invokes the Budget Manager object to retrieve the customer's user identification name and user secret key from the User Authenticator object 507. The Budget Manager sends the pair of user data and other captured data (i.e., current location) for verification to the Web Application object 508. The user identification name and any response from the Web Application are returned to the Merchant Register object 509. If verification of user credentials fails, the procedure stops here.

If client token is implemented at 510, the Merchant Register object sends a call to the Web Application object to generate a client token 511. The Web Application object sends the generated client token to the Budget Manager object 512. The user receives the client token by an on-screen notification message or as an SMS text message. In any case, the user manually enters the client token as prompted by the Budget Manager object 513. The Budget Manager object submits the user's input for verification to the Web Application object 514. The Web Application replies whether or not the user's input matches the client token back to the Budget Manager object, which in turn relays the response to the Merchant Register object 515. If verification of the client token fails, the procedure stops here.

The Merchant Register prepares the transaction, compiling data collected in the procedure to form the transaction data 516. The Merchant Register object then sends the transaction data to the Web Application object 517. The Web Application processes the transaction data, creating a pair of financial records that is associated with a unique transaction identification number. One financial record is designated as a withdrawal in the associated payer's general ledger. The other financial record is designated as a deposit in the associated payee's general ledger. The deposit record applies the total amount in the payment transaction to add that amount to the associated payee's total fund credits. The withdrawal record applies the total amount in the payment transaction to subtract that amount from the associated payer's total fund credits. The Web Application checks for errors and makes corrections if needed in the creation of the pair of financial records. The Web Application further updates the general ledgers of the associated payer and the associated payee to calculate net gain. The Web Application marks the status of the pair of financial records as suspended records. A transaction response containing the transaction identification number, transaction code, and any error code is sent to the Merchant Register object, which in turn relays the response to the Budget Manager object 518. The user then receives the response in the form of an on-screen notification.

In the case that the payment transaction is buying or selling fund credits, the Web Application performs a calculation check on the converted fund credit amount. The variables involved in this calculation are the associated user's country of residence, the country in which the transaction occurs, the exchange rate, the currency amount collected or disbursed, and the fund credit amount. With exception of the country of residence, which is retrieved by looking it up in the associated user's user account, all variables are part of the transaction data. If a discrepancy results in the calculation, the Web Application automatically corrects the fund credit amount, and documents the correction in a message. The transaction response will indicate this intervention to correct the converted amount by showing its corresponding transaction code.

The technical procedure shown in FIG. 6 is activated by an external call, which comes from the merchant's shopping cart process 601. In the stand-alone environment, a third party mobile application program implements a button or a function to send payment data and the merchant's user identification name to the Budget Manager object. The Budget Manager object holds the received data in memory until it is ready to prepare the data for processing. The Budget Manager object retrieves the customer's user identification name and the user secret key from the User Authenticator object 602. The Budget Manager sends the pair of user data and other captured data (i.e., current location) for verification to the Web Application object 603. Any response from the Web Application is returned to the Budget Manager object. If verification of user credentials fails, the procedure stops here.

If client token is implemented at 604, the Budget Manager object sends a call to the Web Application object to generate a client token 605. The Web Application object returns the generated client token to the Budget Manager object. The user receives the client token by an on-screen notification message or as an SMS text message. In any case, the user manually enters the client token as prompted by the Budget Manager object 606. The Budget Manager object submits the user's input for verification to the Web Application object 607. The Web Application replies whether or not the user's input matches the client token back to the Budget Manager object. If verification of the client token fails, the procedure stops here.

The Budget Manager prepares the transaction, compiling data received in the procedure to form the transaction data 608. The Budget Manager object then sends the transaction data to the Web Application object 609. The Web Application processes the transaction data in the same procedure as described in FIG. 5, 517, creating a pair of financial records that is associated with a unique transaction identification number. A transaction response containing the transaction identification number, transaction code, and any error code is returned to the Budget Manager object. If applicable, the Budget Manager object relays the transaction response back to the third party mobile application program.

The technical procedure in FIG. 7 shows how a user can set up and execute one or more recurring payment transactions. A payment transaction that only occurs one time can be set up and executed as well. The Budget Manager object is launched and immediately retrieves the customer's user identification name and user secret key from the User Authenticator object 701. The Budget Manager object sends the pair of user data and other captured data (i.e., current location) for verification to the Web Application object 702. Any response from the Web Application is returned to the Budget Manager object.

While the user may perform another function as programmed in the budget manager mobile application program, the Budget Manager object carries out a background data synchronization task to check whether the Web Application object has any new data records 703. New data records, if any, are returned and stored in the local database of the budget manager mobile application program. Any data records created or modified in the budget manager program are sent to the Web Application object at this time as well to ensure that both the remote server and the client computer have the same data records. Depending on the amount of data, data synchronization may take a few or several seconds or longer. This is why data synchronization is carried out in the background, so that the user may perform another function or task.

The user browses through a list of payee accounts 239 (see FIG. 2B) to select from in the Budget Manager object 704. If a payee is not found, the user can access a new payee account data entry form in the Budget Manager object 705. Payee data include unique identification name, legal name, address, city or town, postal code, country, telephone, e-mail address, and description. The user may search the Web Application object to select an existing user to be a payee, or the user may enter completely new information. A newly created payee by the user is preferably only visible to that user, and is labeled in such a way as to make it clear that the payee is only a payee who cannot log in as a regular user. The role type in the case of a newly created payee is “Unverified Payee.” This control prevents a user from overriding the normal user registration process as described in FIG. 3. The user submits the completed payee account data entry form where upon the Budget Manager object sends the payee data to the Web Application object for processing and saving 706. The Web Application object then returns a response to the Budget Manager object.

A payee created by a user may be a family relative, a friend, a colleague, a business entity, or some other person or entity. This allows a user (the payer) to send fund credits to another user (the payee) for a reason not normally considered as buying a good or a service. For instance, a user sends a remittance to a family relative in another country.

The user browses through a list of transaction registrations 238 (see FIG. 2B) to select from in the Budget Manager object 707. An existing transaction can be modified by the user and sent to the Web Application object for saving 708. The user can add a new transaction by accessing the new transaction registration data entry form in the Budget Manager object 709. Transaction registration data include the payee's identification name, total amount, date of execution (start date), date of termination (end date), frequency period (i.e., one time, daily, weekly, or monthly), brief description, and longer description. The user submits the completed transaction registration data entry form where upon the Budget Manager object sends the data to the Web Application object for processing and saving 710. The Web Application object then returns a response to the Budget Manager object. At this point, the user has completed setting up a transaction registration, either by adding a new one or modifying an existing one.

The Web Application object automatically executes a transaction registration based on the settings just described 711. For example, a transaction registration is set to pay 750.25 fund credits on a monthly basis to Acme from 1 Nov. 2017 at 03:00 to 31 Oct. 2018 at 02:59. The first transaction will occur on 1 Nov. 2017 at 03:00 and will repeat once a month at the same time thereafter. The last transaction will occur on 1 Oct. 2018 at 03:00. The Web Application processes the transaction registration in the same procedure as described in FIG. 5, 517, creating a pair of financial records that is associated with a unique transaction identification number. The one exception, however, is that the Web Application marks the status of the pair of financial records as cleared records. It is presumed that there is no need to cancel the executed transaction. Thus, the transaction registration bypasses the final approval segment. Upon completing execution of each transaction registration, the Web Application object will send a result of the transaction processing to the Budget Manager object 712. The result contains the transaction identification number, transaction code, and any error code. A message verifying the transaction result is sent to both the payer and the payee. Of course, the schedule can change when the user modifies the settings. The schedule can stop completely if the user chooses to delete the transaction registration at any point before the date of termination.

The user can stop the next scheduled payment transaction in a transaction registration. Preferably up to four alert notifications may be sent to the payer to provide information regarding an upcoming payment transaction. Each on-screen notification states the number of hours to execution and provides input options for the payer to select okay or stop. The payer's response of an okay input selection indicates that the scheduled transaction will be executed. An okay response is similar to ignoring the notification, but the response is documented in the form of a message. The payer's response of a stop input invokes the Web Application object to edit the upcoming payment transaction by marking it as a “Stopped” transaction. A scheduled transaction that has this mark will not be executed. The Web Application documents this modification in the form of a message. Once a stop has been made, no further alert notifications will be sent. The first alert notification is sent at 72 hours before the scheduled execution, and is documented in the form of a message. The second alert notification, if no stop response was received, is sent at 48 hours before the scheduled execution. The third alert notification, if no stop response was received, is sent at 24 hours before the scheduled execution. The fourth and final alert notification, if no stop response was received, is sent at six hours before the scheduled execution. Note that stopping an upcoming payment transaction does not delete the transaction registration. The user can stop the next scheduled transaction, but the next one after that can still be executed.

In accordance with the payment business process in FIGS. 4A and 4B where applicable, a response in the negative or an error at a particular point stops the technical procedure. Completion of the technical procedure in its entire sequence assumes that no errors had occurred. A warning is permissible and may not stop the procedure. This applies in FIGS. 5, 6, and 7.

Whenever the Web Application object processes a call or a request and returns a response, the Web Application object creates and saves a new message associated with the user to document the activity. The generated message may contain additional information such as current location, current date and time, client IP address, server IP address, and referral URL as can be captured by the Web Application object and the Budget Manager object, so as to provide details to the user in any event that the user needs to diagnose a problem that may have occurred in processing the request. Any generated message can also serve to identify unusual activity or a possible intrusion by an unauthorized user. Generated messages are utilized in the process of reconciling financial records to resolve inaccuracies or errors found in reconciliation. The user can view any or all generated messages in the notification and messaging section of the budget manager mobile application program 240.

The technical procedures and corresponding business processes have up to this point covered the immediate processing of a payment transaction. This is the payment segment. In preferred embodiments there are three additional segments, i.e. final approval segment, dispute segment, and reconciliation segment, for further confirmation and verification. In the final approval and dispute segments, both the payer and the payee associated with a particular transaction should be required to expressly acknowledge each other's request. The two-way communication ensures that both parties in the transaction are informed.

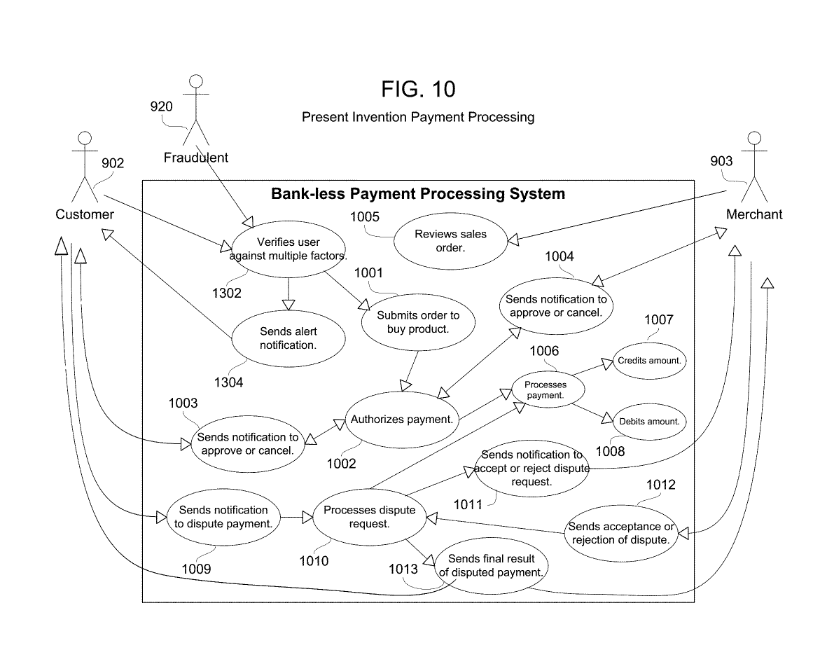

The user can view the newly processed transaction in their general ledger either in the Web application program or in the budget manager mobile application program. (See FIG. 10 below and the associated description for additional details regarding the payment processing functions.) Since a pair of financial records is created, the associated payer sees the withdrawal record and the associated payee sees the deposit record. In both views, a cancel button and an approve button are displayed for the record. These two functions are only available for a suspended financial record. Either the payer or the payee can send a request to cancel or approve the suspended record. The payer or the payee clicks on the cancel button to invoke the Web application to process the action by sending an alert notification to the payee or the payer, respectively. To be clear: the payer invokes the action to send an alert to the payee and vice versa. The notification displays as an on-screen message with input options to select confirm cancelation or reject cancelation and to enter instructions such as for returning the sold product. If the respective recipient returns a response with the reject input or ignores the notification, the financial records' present status is maintained. The Web application processes a response received from the respective recipient and relays the recipient's selected input to the initiator of the request. If the selected input is a confirm cancelation, the Web application edits the financial records' status to change it to “Canceled,” and then removes the now canceled records from display in the general ledgers of the associated payer and the associated payee. The Web Application further updates the general ledgers of the associated payer and the associated payee to calculate net gain. The Web application sends a response describing the result to both the payer and the payee.

The payer or the payee can choose to expressly approve the suspended record. The payer or the payee clicks on the approve button to invoke the Web application to process the action by sending an alert notification to the payee or the payer, respectively. To be clear: the payee invokes the action to send an alert to the payer and vice versa. The notification displays as an on-screen message with input options to select confirm approval or reject approval. If the respective recipient returns a response with the reject input or ignores the notification, the financial records' present status is maintained. The Web application processes a response received from the respective recipient and relays the recipient's selected input to the initiator of the request. If the selected input is a confirm approval, the Web application edits the financial records' status to change it to “Cleared.” The Web Application further updates the general ledgers of the associated payer and the associated payee to calculate net gain. The Web application sends a response describing the result to both the payer and the payee.

The cancel and approve functions are preferably available for a limited time period. After 72 hours (three days) from the transaction date (payment date), the suspended record will become cleared automatically with no user input. After 72 hours without user input, the Web application edits the financial records' status to change it to “Cleared.” This automated action is documented in the form of message. The payer may dispute a cleared financial record within a limited time period. After 336 hours (14 days or two weeks), the ability to dispute a cleared financial record is preferably no longer available.

Between 72 hours and 336 hours from the transaction date (payment date), a dispute button is displayed for the cleared record in the payer's general ledger. The payer clicks on the dispute button to open a data entry form where the payer selects a reason from a pre-defined list of reasons or enters a reason in an input text field. The payer then submits the selected or entered reason as a request to dispute the record. The Web application receives the dispute request, documenting the submitted reason in the form of a message. The Web application edits the financial records' status to change it to “In-Dispute,” and sends an alert notification to the payee to accept the dispute. The payee receives an on-screen notification with input options to select accept dispute or reject dispute, to enter a reason, and to enter instructions such as for returning the sold product. The associated financial record in the payee's general ledger displays an accept button, while the associated financial record in the payer's general ledger displays a “Pending Dispute” label. The payee can respond immediately via the on-screen notification or can respond later but within the time limit. If responding later, the payee can click on the accept button to open a data entry form where the payee selects accept dispute or reject dispute, enters a reason, and enters instructions such as for returning the sold product. In either case, the Web application receives the dispute response, documenting the submitted reason and instructions in the form of a message. If the selected input is a reject dispute or if the payee ignores the dispute, the financial records' present status is maintained. If the selected input is an accept dispute, the Web application edits the financial records' status to change it to “Disputed,” and then removes the now disputed records from display in the general ledgers of the associated payer and the associated payee. The Web Application further updates the general ledgers of the associated payer and the associated payee to calculate net gain. The Web application sends a response describing the result to both the payer and the payee.

The last reconciliation segment checks for inaccuracies and errors in the calculations and other data related to the financial records. Net gain or loss is a calculation of only cleared financial records. The Web application provides a scripted procedure that executes automatically during the first week of the current month to compile all financial records differentiated by transaction status for the most recent, previously completed month. The user can use this procedure to execute reconciliation at any time. The user may also change the time period from a single month to a single quarter or a single year and specify dates for the time period. For instance, reconciliation can be conducted for the month of February 2015, or can be conducted for the quarter starting from April 2017 and ending June 2017. A reconciliation button with input options to select the time period and specific dates is displayed in the transaction report section. The user makes input selections and clicks on the reconciliation button to send a request to the Web application to execute reconciliation.

Whether manually initiated or automatically executed, the reconciliation procedure is activated. The Web application processes the request. Financial records are compiled by transaction status (i.e., all suspended records grouped together and all cleared records together). The Web application focuses on cleared financial records to provide a detailed list of those records. The details of each record include the payer, the payee, total amount, description, and other transaction data. All other groups are analyzed and displayed in aggregated form (i.e., total suspended records, total amount in suspended records, total disputed records, and total amount in disputed records). Financial records associated with found inaccuracies or errors are labeled with an error marking. In the case of found inaccuracies or errors, the Web application further compiles the associated documented messages. The Web application produces a summary of the reconciliation in the form of key budget management statistics, which consists of total deposit, total withdrawal, net gain or loss, budget limit, and under/over budget percentage. The net gain formula is the difference of total deposit and total withdrawal. A positive net gain indicates a surplus, and a negative net loss indicates a deficit. Budget limit is a fixed amount specified by the user. The under/over budget percentage formula is the difference of budget limit and total withdrawal divided by budget limit and multiplied by 100. A positive percentage indicates under budget, a negative percentage indicates over budget, and a zero percentage indicates on budget. The summary calculations are reflective of cleared financial records. The result of produced calculations and detailed listing of cleared financial records is generated in a pre-formatted RTF document that can be easily read by a human user and printed on one or more sheets of paper. The generated RTF document is labeled as an “Unconfirmed Report” and is stored in a secured location in the remote computer server.

The Web application then sends an alert notification to the user to review the result of the reconciliation. The on-screen notification provides an URL address to download and save the generated RTF document to the user's computer. The transaction report section displays an accept reconciliation report button. The user clicks on this button to open a data entry form to select accept or reject and to enter a reason or a note. The Web application receives the user's input, documenting the submitted reason or note in the form of a message. If the user takes no action, the generated RTF document remains unmodified and maintains its label as an Unconfirmed Report. If the selected input is a reject reconciliation, the Web application edits the generated RTF document to change its label to an “Unconfirmed and Rejected Report.” If the selected input is an accept reconciliation, the Web application edits the generated RTF document to change its label to a “Confirmed and Accepted Report.” No other data in the report is modified in either case. The Web application finally sends a response describing the result to the user. All generated confirmed and unconfirmed reconciliation reports are located in the transaction report section where the user can download and save each one to their computer.

The Web application may execute one or more calculations to produce one or more budget management statistics and send the result in the form of an alert notification to the user. This result would not be generated in an RTF document but displayed as an on-screen notification and documented in the form of a message. An example calculation is net gain relative to zero. The resultant message would describe how far the user's fund credits is from zero, positive or negative, or if the user's fund credits is zero. Another example calculation is under/over budget percentage. The resultant message in this case would show the calculated percentage. The calculations may be cumulative of all financial records regardless of status or may be limited by a specified transaction status or a specified time period. The user can save specified settings in the transaction analysis function, which the Web application will apply in processing the calculations. The user may save a setting for a threshold amount that generates an alert notification when fund credits have reached a specified amount relative to the net gain or the budget limit.

The resultant message of any of the calculations may include input options related to specific actions that the user can take. For example, an input option is to find the nearest money exchange store to purchase more fund credits. Another input option is to edit the user's account to reflect a locked or suspended status, so that the user cannot send or receive any payments or perform any function. Another input option is to continue to allow deposits to be made but withdrawals, on the other hand, are blocked. In this case, an attempt to process a payment will be declined. Yet another user can still send fund credits to that user in the form of a deposit. The Web application stores numerous input options along with corresponding pre-defined scripted procedures. A pre-defined scripted procedure is executed to carry out an input option.

The Web application applies the calculation and compares it against a threshold amount and business rules. The Web application then uses the result of the calculation and comparison to select one or more input options. The Web application prepares the alert notification with the input options. No input options will be presented if none can be found.

The user returns a response with a selected input action to the Web application. The Web application then processes the response, documenting any input selection in the form of a message. The Web application processes the selected input by retrieving the corresponding pre-defined scripted procedure and executing the procedure. In the example of finding a money exchange store, the Web application searches for merchant users who are located near the user based on the captured location data. The search result is presented to the user in a new screen that provides a list of nearby merchant users with their business address and telephone number.

FIG. 8 shows a business process for a money exchange store to verify a customer and to deposit or withdraw fund credits. A customer could use a money exchange store to purchase fund credits and to convert their fund credits into local currency. The business process represents Scenario 2 where in an in-person operation, a customer interacts with a merchant.

The customer walks up to the merchant so that the customer's mobile phone can be close to the merchant's touch-screen computer. This allows the merchant's computer to find the customer's mobile phone and establish a Peer-to-Peer connection link. The two computing devices are paired together with an expressed permission by the customer at 801. The merchant register mobile application program (merchant's computer) communicates with the budget manager mobile application program (customer's computer). The merchant's computer sends a message to connect with the customer's computer. The customer can respond back with an accept or a reject input. If rejected, a Peer-to-Peer connection link is not established and the process ends. If accepted, a Peer-to-Peer connection link is established. The customer retrieves their user identification name from the user authenticator mobile application program and sends it to the merchant's computer.

User authentication is activated to identify the customer at 802. If available, a current location of the mobile device as represented by a GPS coordinate (i.e., latitude and longitude), at time of transaction, is captured (user authentication factor). A telephone number of the mobile device, which is in use at time of transaction, is also captured (user authentication factor). The customer's user identification name and user secret key are retrieved from the user authenticator mobile application program (user authentication factor). If the Web application program returns a response that one of the submitted factors does not match the customer's stored user account information in the remote computer server or is invalid, the business process ends.

The merchant register program starts with the customer's user identification name, which was received as a result of establishing the Peer-to-Peer connection, to create a new sales order. At this point, the merchant can view the customer's user account profile at 803. The merchant may ask the customer for photo identification. The customer responds by presenting a passport, a driver's license, or another form of government-issued photo identification 804. Additional forms of identification may be requested. The merchant may check to make sure that the information in the photo identification and any other documentation matches the profile as presented on the computer screen at 805. The business process ends if the information does not match.

On a successful match (straight down in box 805), the merchant proceeds to prepare the customer's order at 806. The merchant asks the customer if they wish to buy fund credits or to sell fund credits 807. Buying credits will add (deposit) credits to the customer's account. Selling credits will reduce (withdraw) credits from the customer's account. In either case, the steps in the business process moving forward are basically the same.

If the customer chooses to buy fund credits, he or she will specify how much to buy. The merchant adds a buy item record in the sales order in the merchant register program. Based on the customer's country of residence, the merchant register program converts the local currency into fund credits at the current market exchange rate or another rate supplied by the merchant.

The exchange rate can be pegged to a local currency so that, for users in that country, there is a one to one ratio. For example, if the fund credits are pegged to the U.S. dollar, then an American customer exchanges USD 150.25 for 150.25 fund credits. If it is desired that fund credits have the same value anywhere in the world, then, of course, the fund credits can only be pegged to one local currency. In the example where the fund credits are pegged to the U.S. dollar, a Japanese customer exchanges JPY 1,200.00 for a number of fund credits that corresponds to the exchange rate at that time. For example, if 1 JPY is equal to 0.01 U.S. dollar, then JPY 1,200.00 would be equal to 12 fund credits.

As an alternative, the amount of fund credits can be made equal to the amount of the local currency of the country in which the customer resides. Thus, a Japanese customer who exchanges JPY 1,200.00 would acquire 1,200 fund credits whereas a U.S. customer who exchanges $1,200,00 would also acquire 1,200 fund credits. In this case, of course, fund credits would not have a constant value anywhere in the world (i.e., a fund credit in Japan would not be equal to a fund credit in the U.S.). Appropriate exchange rates are then used for cross-border transactions.

A customer who uses the present invention in multiple countries will see a difference in the exchange rate as they buy fund credits in one country and then sell fund credits in another country. For example, an American customer exchanges USD 150.25 for 150.25 fund credits in the United States. He then travels to Japan and chooses to sell his credits. At an authorized store in Tokyo, he exchanges 150.25 fund credits for JPY 15,025.00 (assuming the same exchange rate mentioned above). In another example, a Ghanaian customer exchanges GHS 100.00 for 100.00 fund credits. She then travels to France. At an authorized store in Paris, she exchanges 100.00 fund credits for EUR 18.99. The country in which a customer resides may exchange fund credits at a one to one ratio when the fund credits are not pegged to a single currency worldwide. When that same customer goes to another country, the customer exchanges fund credits at the current market exchange rate.

The merchant records the exchange rate in the sales order and presents it along with the converted value to the customer at 808A. The merchant register mobile application program calculates the conversion and displays it on screen. The budget manager mobile application program can also calculate the conversion. The merchant may apply an exchange rate that is slightly different from the market rate for the purpose of making a profit.

The customer makes a decision to accept the exchange at the given rate at 809A. The process ends if the customer rejects or declines. On acceptance, the merchant finalizes the sales order and prepares to make a payment transaction. The merchant submits a command in the merchant register program for the Web application program to generate a client token 810A. The customer manually enters an eight-digit numeric code as prompted by the budget manager program, which then sends the customer's input to the Web application 811A. If the customer submits the token after the time limit, the process ends. If within the time limit, the customer's input is checked to make sure that it matches the generated client token 812A. If the input does not match, the customer has two more tries to enter the correct token. The process ends after three failed attempts to send the client token.

On a successful match, several data fields are collected and compiled to form the transaction data. A sales order identification number is included in the transaction data. The compiled transaction data is sent as a request to the Web application program for transaction processing. In this particular case, the Web application program processes the transaction in the form of a deposit, adding the amount of fund credits to the customer's account 813A. The Web application program returns a transaction response, and the response presents an on-screen message to the customer, showing a unique transaction identification number, a transaction code, and an error code (if an error had occurred). At this point, the merchant collects cash payment from the customer at 814A.

If the customer chooses to sell fund credits at 807, the merchant adds a sell item record in the sales order in the merchant register program. Based on the customer's country of residence, the merchant register program converts the fund credits into local currency at the current market exchange rate or another rate supplied by the merchant. The merchant records the exchange rate in the sales order and presents it along with the converted value to the customer at 808B.

The customer makes a decision to accept the exchange at the given rate at 809B. The process ends if the customer rejects or declines. On acceptance, the merchant finalizes the sales order record and prepares to make a payment transaction. The merchant submits a command in the merchant register program for the Web application program to generate a client token at 810B. The customer manually enters an eight-digit numeric code as prompted by the budget manager program, which then sends the customer's input to the Web application at 811B. If the customer submits the token after the time limit, the process ends. If within the time limit, the customer's input is checked to make sure that it matches the generated client token at 812B. If the input does not match, the customer has two more tries to enter the correct token. The process ends after three failed attempts to send the client token.

On a successful match, several data fields are collected and compiled to form the transaction data. A sales order identification number is included in the transaction data. The compiled transaction data is sent as a request to the Web application program for transaction processing. In this particular case, the Web application program processes the transaction in the form of a withdrawal, deducting the amount of fund credits from the customer's account at 813B. The Web application program returns a transaction response, and the response presents an on-screen message to the customer, showing a unique transaction identification number, a transaction code, and an error code (if an error had occurred). At this point, the merchant disburses cash payment to the customer at 814B.

In another embodiment, the business process in FIG. 8 may be fully automated in an unmanned, self-service kiosk. A customer would walk up to the kiosk and follow the steps in the process through a series of on-screen displays that prompt the customer to make input selections. Of course, one or more steps have to be adapted to be operative in electronic form. A decision step would be presented to prompt the customer with input options to select. The buy or sell decision displays the options to select buy or sell at 807. The customer would be able to select an option on the multi-touch screen. The decision step for accepting or rejecting an exchange at a buy 809A or a sell 809B would be presented to prompt the customer to select accept exchange or reject exchange. In order to collect cash payment, a mechanical cash acceptor device is installed in the kiosk and configured to communicate with the merchant register program at 814A. To disburse cash payment, a mechanical cash dispenser device is installed in the kiosk and configured to communicate with the merchant register program at 814B. Depending on the country of deployment, the merchant register program is programmed to collect and disburse the local currency. A digital camera is installed in the kiosk and configured to communicate with the merchant register program. At the step that asks for photo identification, the camera will position itself with some adjustment by the customer via the multi-touch screen to capture a digital image file representing the physical appearance or likeness of the customer at 804. The merchant register program then sends the digital image file to the Web application program for matching against the customer's digital image file stored in the remote computer server. Of course, a person will, from time to time, empty out the cash acceptor device, refill the cash dispenser device, and check that the kiosk is functioning properly.

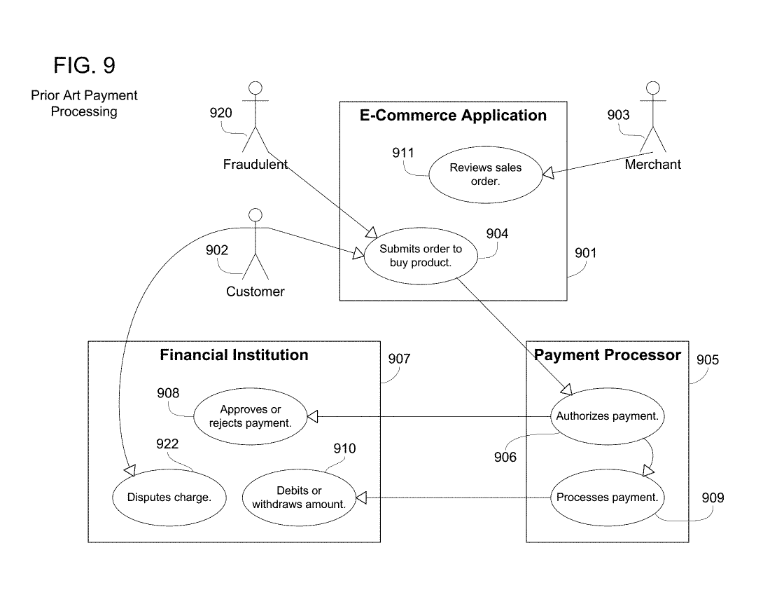

In order to more fully understand certain features of the preferred embodiments, reference is made to FIGS. 9-13. FIG. 9 shows a prior art payment processing system and certain disadvantages associated therewith. An e-commerce application 901 allows a legitimate customer 902 to buy products from a merchant 903. When customer 902 submits an order 904, that order is processed by a third party payment processor 905. Payment processor 905 enacts a payment authorization process 906 that contacts a financial institution 907. Financial institution 907 enacts a process 908 which will either approve or reject the payment, for example, based on whether a credit card used for the purchase has been reported stolen. The result of process 908 is reported back to the payment processor 905, which in turn reports back to the e-commerce application 901 and the transaction is approved or declined. Payment processor 905 also uses a process 909 to process the payment when approved, which will report the payment to the financial institution 907, which uses a process 910 to debit or withdraw funds from the customer's account. Merchant 903 is normally not involved in the approval process and merely reviews the sales order using a process 911 and, if approved, delivers the purchased goods.

When a fraudulent user 920 attempts to make a purchase using e-commerce application 901, a similar approval process is carried out, and, unless the credit card has been reported stolen, or some other fraud trigger has been activated, the purchase may be approved and the merchant 903 will cause the goods to be delivered to the fraudulent user 920. Customer 902 may eventually see the fraudulent transaction and activate a process 922 at financial institution 907 to dispute the charge. However, often by the time this process is activated the fraudulent user will have collected the goods.

FIG. 10 shows a payment processing system in accordance with one embodiment of the present invention. The Bank-less payment processing system preferably involves the genuine customer 902 and the merchant 903 in all transactions, thereby more effectively identifying fraud. Specifically, when either a genuine customer 902 or a fraudulent customer 920 attempts to submit an order they must go through a verification process 1302 which verifies the user against multiple factors, as discussed in detail elsewhere herein. If process 1302 approves the user, it will invoke process 1304 to send an alert notification to genuine customer 902. Thus, if fraudulent customer 920 somehow manages to get approval via process 1302, the genuine customer 902 will immediately get a notification and can dispute payment as discussed below.

Process 1302 will also invoke process 1304 to send an alert notification to genuine customer 902, in the event of a rejection or warning. Thus, in any attempt by fraudulent customer 920 to access the system, the genuine customer 902 will receive a notification.

After authentication process 1302, the customer submits an order to buy a product using process 1001, and the system proceeds to authorize payment in process 1002. Process 1003 sends an approval or cancel notification to the authorized customer 902. The authorized customer 902 will cancel an order made by the fraudulent customer 920 while, of course, approving any orders the authorized customer made. If the authorized customer 902 responds and cancels the order via process 1003, then process 1002 will be informed and will decline to authorize and will reject the payment using process 1002. Of course, if the authorized user 902 responds and approves the order, then process 1002 will authorize and approve the payment.

Process 1002 also invokes process 1004 to send an approval or cancel notification to the merchant 903. If the merchant 903 responds and cancels the order via process 1004, then process 1002 will be informed and will decline to authorize and will reject the payment using process 1002. If the merchant 903 responds and approves the order, then process 1002 will authorize and approve the payment.

The first authorized user (whether it is the genuine customer 902 or the merchant 903) who responds to the approval or cancel notification will have their response processed by the system. If the genuine customer 902 responds first, then the response made by the merchant 903 after the genuine customer 902 will preferably not be processed. On the other hand, if the merchant 903 responds first, then the response made by the genuine customer 902 after the merchant 903 will preferably not be processed.

If payment is approved, a process 1006 is used to process the payment, and will credit the merchant account using process 1007 and debit the customer account using process 1008. Because the merchant is involved in the approval process, the merchant can review the sales order at 1005 and may also decline approval if fraudulent behavior is suspected.

In this embodiment, disputes are also managed automatically by the system and involve both the authorized customer and the merchant. For example, customer 902 can dispute a charge that was previously approved using process 1009. A dispute process 1010 will process the dispute request and invoke a process 1011 to send a notification of the dispute to the merchant 903. Merchant 903 can accept or reject the dispute using a process 1012. Process 1010 eventually resolves the dispute by allowing the customer 902 and merchant 903 to communicate with each other. (The dispute resolution process is discussed above.) For example, merchant 903 may agree that the product arrived in poor condition and agree to a refund. Acceptance or denial of a disputed claim is communicated to the customer 902 and merchant 903 using process 1013.

When the dispute is resolved, process 1010 notifies process 1006. Process 1006 applies proper credits (1007) and debits (1008) as appropriate. For example, if a dispute results in a refund, then the customer 902 will receive a credit and merchant 903 a debit.

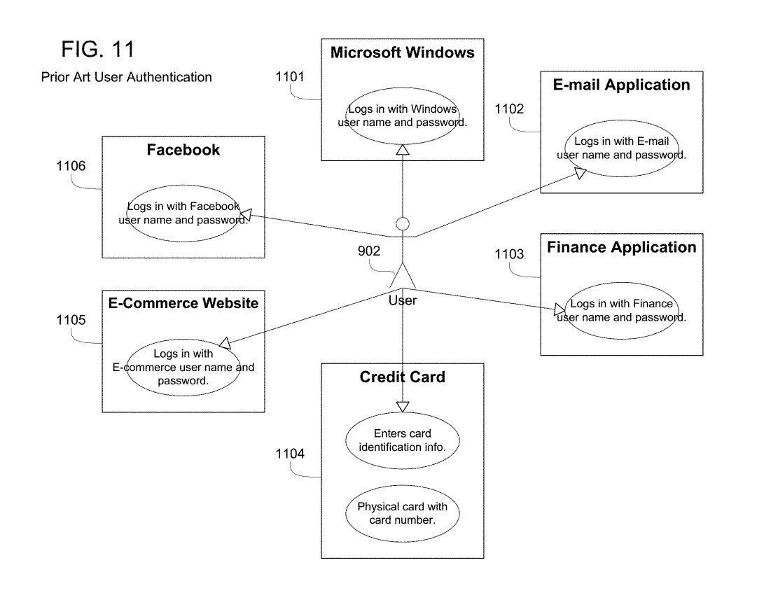

FIG. 11 shows a prior art user authentication method in various applications, namely Microsoft Windows 1101, an e-mail application 1102, a finance application 1103, a credit card account 1104, an e-commerce Website such as Amazon 1105, and a social media account such as Facebook 1106. For each such application the user 902 must manually enter a user name and password in order to log in and access the application's functions. In the case of the credit card, the user 902 must enter the credit card number, card expiration date, billing address, and a card verification code. This places a burden on the user to remember the necessary details for each account. To lessen the burden the user may use one universal password or a very simple password for all accounts. This of course has well-known security risks. The user may come up with creative ways to remember their password such as writing it down on a poste-it note and displaying it in plain sight on their computer monitor. FIG. 11 illustrates the problems of logging in to multiple applications.

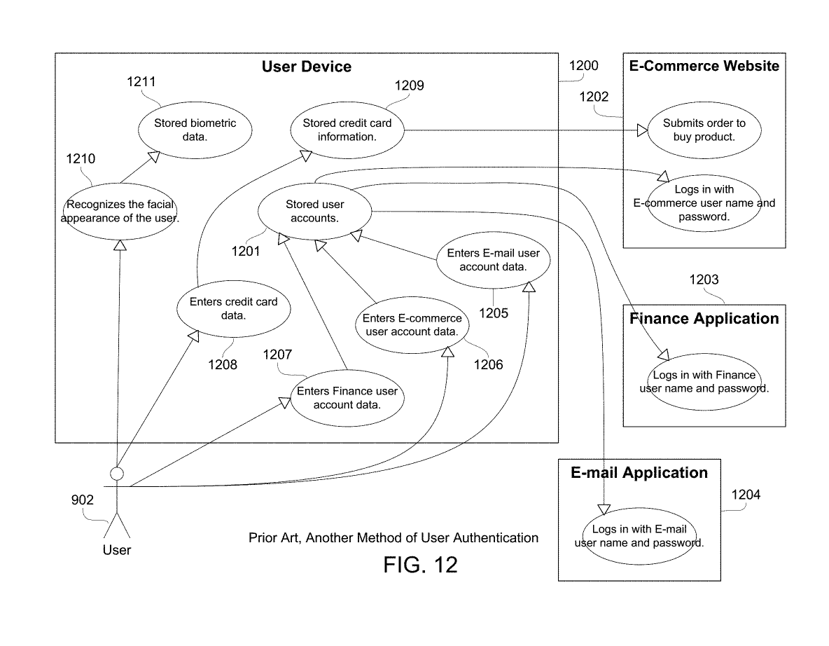

FIG. 12 shows an alternative user authentication method practiced in some prior art applications. A user device 1200, such as an iPhone, includes a process 1201 that stores user account information for multiple accounts, such as for an e-commerce Website 1202, a finance application 1203, and an e-mail application 1204. A user 902 enters his or her e-mail account information (1205), e-commerce (e.g., Amazon) information (1206), and finance application information (1207) for storage by the process 1201 prior to using the applications. The user can also enter credit card information (1208), which is stored by a process 1209. The user would enter any one or all of the account information and credit card information at their convenience prior to using the account and credit card. The user device 1200 can use a process to authenticate the user 902 such as recognizing the facial appearance of the user at process 1210, which does the authentication based on previously stored biometric data in process 1211. The user 902 would have had gone through a process at the time of setting up their user device 1200 for the first time to capture the user's facial appearance and store the resultant biometric data in process 1211. Thereafter, once the user has been authenticated by process 1210, the user device 1200 can use process 1201 to facilitate logging into the various applications 1202, 1203 and 1204. It can also provide credit card information to a process, such as Amazon, to facilitate a purchase. While FIG. 12 does make it easier and more secure to log in to multiple applications, it does not fundamentally change the way in which the user logs in to an application. The user still holds several sets of login user credentials for all applications.

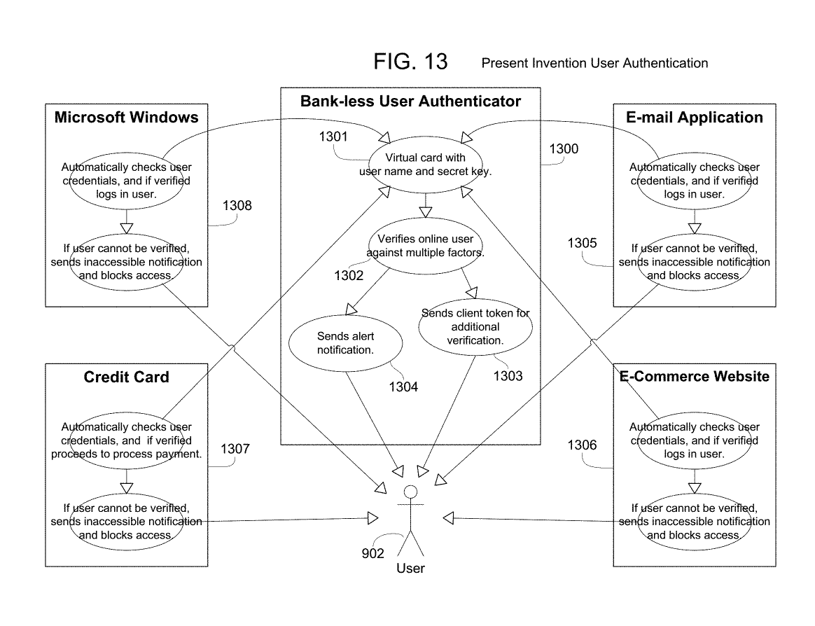

FIG. 13 shows a user authentication method in accordance with one embodiment of the present invention. A Bank-less user authenticator process 1300 includes a process 1301 that establishes a virtual card with a user name and a secret key pair of user credentials. A user is verified by authenticator 1300 using multiple factors in a process 1302. The factors, as discussed above, can include a user name and password, biometric information, etc. A client token process 1303 can also be used for an additional level of security as discussed above. Process 1304 sends an alert notification directly to a user device, such as a cellular phone, associated with the user account whenever an authorization attempt is made. An alert notification may also be sent to an e-mail address associated with the user account. Whenever a user utilizes any third party application requiring a login procedure, such as an e-mail application 1305, an e-commerce Website like Amazon 1306, a credit card application 1307, or a Windows application 1308, the application invokes a process that automatically checks with the Bank-less user authenticator and will log in the user if he or she has been verified by process 1302. If the user cannot be verified, then each application sends an inaccessible notification to the user and blocks access. Blocked access results in a screen that informs the user that the application cannot be used and may include instructions in how to regain access. A third party software developer can modify their existing software application to enable the third party software application to communicate with and access the Bank-less user authenticator 1300 and to receive a response. This would replace the third party software developer's own system for authenticating a user. With this improved system, the user need only retain and remember one set of login user credentials and the user authenticator 1300 will automatically facilitate the user's access to a variety of third party applications. Thus, as long as the user authenticator 1300 program is installed and running on a user's computer (or other device) and has an active and valid user account, the user can automatically log in to multiple software applications, including the operating system of the user device.

Preferred embodiments of the present invention are ideally suited for a user who buys goods and services online with a mobile phone that has a 3G cellular network connection and a data plan. The user can reside in any country and be able to buy a product from a merchant in another country. The user does not need to worry about which local currency to use, and need not pay a foreign transaction fee that is typically incurred with a credit card transaction.

Preferred embodiments of the present invention are also advantageous for a merchant who sells goods and services in an online situation and in a traditional retail situation. With a new form of money that can be applied in multiple countries, the merchant can offer one price in one common unit that opens up a far wider market. The merchant's cost of implementing computer POS systems and related infrastructure is significantly reduced. The merchant does not need to deal with different credit card issuers. And the merchant no longer needs to deal with a payment processor from a third party organization that would charge a transaction fee and a chargeback fee.

Preferred embodiments of the present invention have been disclosed using drawings of a computer system and a computer program to understand and demonstrate certain practical applications of the invention. The description is not intended to be exhaustive and limited to the form of the invention disclosed. Those skilled in the art will appreciate that the present invention may have modifications and variations by way of selecting and using a computer programming language, a computer server application program, a particular computing device, a certain quantity of capacity in computer hardware components, or other computer technology. While such technical details may change a computer system or a computer program, technical details still follow the business processes and technical procedures.

For example, while a mobile phone is an exemplary client computer in the present invention, another type of a computer such as a mobile tablet or a personal computer may be used as the client in the present invention. An IP address associated with a computer can be used as a user authentication factor. The mobile application programs described herein can be reprogrammed to be operative in a different computer operating system application in a personal computer. In particular, the user authenticator mobile application program described herein may be reprogrammed to run in a personal computer.

The present invention could be used in diverse practical applications. An individual household could use the present invention to teach financial literacy. A father can deposit weekly allowances to his daughter's user account. The child would be able to make purchases safely and learn how to manage her funds through budget management. An employer could use the present invention as a payroll system. Funds can be deposited on a monthly basis to every employee. An associated sales order would be created to document earnings, deductions, and taxes. A microfinance firm could use the present invention to manage very small loans or micro-loans to high-risk persons in rural environments. A high-risk person would start a new user account with a small purchase of fund credits. The firm would deposit an amount of fund credits in the high-risk person's account. The high-risk person then would be able to market their small-scale goods and find customers who would buy the unique goods. A multinational corporation or an international organization could use the present invention to move funds more efficiently, safely, and legally across national boundaries. Rather than carrying cash that amounts in thousands of dollars, a businessperson would convert their domestic currency into fund credits before traveling abroad. After arrival in a foreign country, the businessperson would convert their fund credits into foreign currency. A financial institution could use the present invention to modernize banking operations. The financial institution's account holders would be able to manage their savings more actively and confidently with the present invention's security controls and alert notifications. By shifting financial risk to the consumer, the financial institution would be able to approve loans of various amounts to a wider group of borrowers. The financial institution would find significant cost savings in managing accounts with greater information security entirely in an electronic form. No longer would the financial institution have to produce physical cards and send them out via postal mail.

It is understood from the above description that the functionality and features of the systems, devices, or methods of embodiments of the present invention include generating and sending signals to accomplish the actions. It is to be further understood that additional embodiments of the present invention described herein may be contemplated by one of ordinary skill in the art and that the scope of the present invention is not limited to the embodiments disclosed. While specific embodiments of the present invention have been illustrated and described, numerous modifications come to mind without significantly departing from the spirit of the invention, and the scope of protection is only limited by the scope of the accompanying claims.

What is claimed is:

1. A computer-based method for processing transactions related to payments in exchange for goods or services, the method comprising:
receiving an electronic request for access to an account associated with an electronic payment processing system;
determining whether said request is authentic using an authentication protocol and, if said request is not determined to be authentic, rejecting said access request, otherwise preliminarily approving said access request;
if said access request is preliminarily approved, performing the following steps:
sending a message to a user associated with said account notifying said user that said access request has been preliminarily approved;
receiving a response to said message indicating user approval or disapproval of said access request;
if said response from said user indicates disapproval of said access request then denying access to said account; and
if said response from said user indicates approval of said access request, then changing the status of said access request from preliminarily approved to approved; and
wherein when said request for access is approved said electronic payment processing system will process a payment associated with said account.

2. The method of claim 1 wherein said authentication protocol comprises comparing a mobile phone number captured at the time of said request for access to a stored phone number associated with said account.

3. The method of claim 1 wherein said authentication protocol comprises determining whether a location captured at time of said request for access is within a predetermined range of the last location at which a successful transaction had been completed for said account.

4. The method of claim 1 wherein said authentication protocol comprises determining whether a location captured at time of said request for access is within a predetermined distance from the mean value of a compilation of a historical locations associated with successful transactions for said account.

5. The method of claim 1 wherein said authentication protocol comprises comparing a digital image representing the physical appearance of a person captured at the time of said request for access to stored image data associated with said account.

6. The method of claim 1 wherein said electronic payment processing system will process a payment associated with said account by decrementing said account and crediting a merchant account associated with a merchant of a good or service.

7. The method of claim 1, wherein said electronic payment processing system will not process a payment associated with said account in the event that the amount of said payment exceeds a predetermined budget associated with said account.

8. The method of claim 1 wherein in the event that the amount of said payment exceeds a predetermined budget associated with said account a warning message will be sent to said user.

9. The method of claim 8 wherein in the event that said warning message is sent to said user, said method will further comprise the step of receiving a response to said warning message from said user, said response including either an approval or a disapproval of said payment.

10. The method of claim 1 wherein said electronic payment processing system will not process a payment associated with said account in the event that the amount of said payment, when combined with all payments processed for said account during a predetermined period of time will collectively exceed a predetermined budget associated with said account.

11. A non-transitory processor readable medium for carrying out the computer-based method of claim 1 comprising processor readable instructions that when executed by the computer processor cause the computer processor to perform the method.

12. A computer-based method for resolving a dispute between a purchaser of a good or service and a merchant who provided the good or service, the method comprising:
receiving a message from said purchaser contesting a transaction previously consummated between said purchaser and said merchant, said message containing data concerning the basis for said user contesting said transaction;
sending a message to said merchant informing said merchant that said transaction is being contested and providing said data;
receiving a message from said merchant containing a response that includes either an acceptance of said basis or a rejection of said basis; and
wherein if said message from said merchant includes an acceptance of said basis, automatically crediting an account associated with said purchaser and automatically decrementing an account associated with said merchant.

13. The method of claim 12 further comprising the step of facilitating an exchange of information between said purchaser and said merchant following said step of sending and before said merchant either accepts or rejects said basis for said user contesting said transaction.

14. The method of claim 12 wherein said transaction was the purchase of goods from said merchant using the Internet.

15. The method of claim 12 wherein said step of receiving a message from said merchant further comprises receiving data from said merchant supporting said merchant's reasons for rejecting said basis.

16. The method of claim 12 further comprising the step of sending a message to said purchaser in the event said merchant rejects said basis and including in said message data received from said merchant supporting said merchant's reasons for rejecting said basis.

17. A non-transitory processor readable medium for carrying out the computer-based method of claim 12 comprising processor readable instructions that when executed by the computer processor cause the computer processor to perform the method.

18. A computer-based method for authorizing users related to user logins in automatically granting or denying access to secure applications, the method comprising:
receiving an electronic request for access to an account associated with a third party software application;
determining whether said request is authentic using an authentication protocol and, if said request is not determined to be authentic, denying said access request and redirecting said access request to an access denied screen, otherwise granting said access request and redirecting said access request to a secured entry screen of the third party software application;
if said access request is denied, performing the following steps:
sending a message to a user associated with said account notifying said user that said access request has been denied; and
receiving a response to said message indicating user acknowledgement of said access request; and
wherein when said request for access is granted said third party software application will allow said user to access software functionality therein.

19. The method of claim 18 wherein said authentication protocol comprises comparing a mobile phone number captured at the time of said request for access to the stored phone number associated with said account.

20. The method of claim 18 wherein said authentication protocol comprises determining whether a location captured at time of said request for access is within a predetermined range of the last location at which a successful user login had been made for said account.

21. The method of claim 18 wherein said authentication protocol comprises determining whether a location captured at time of said request for access is within a predetermined distance from the mean value of a compilation of a historical locations associated with successful user logins for said account.

22. The method of claim 18 wherein said authentication protocol comprises comparing a digital image representing the physical appearance of a person captured at the time of said request for access to stored image data associated with said account.

23. A non-transitory processor readable medium for carrying out the computer-based method of claim 18 comprising processor readable instructions that when executed by the computer processor cause the computer processor to perform the method.
